(19) United States
(12) Patent Application Publication
(10) Pub. No.: US 2026/0206086 A1
(43) Pub. Date: Jul. 16, 2026

(54) METHOD AND DEVICE FOR REPORTING BASEBAND RESOURCE CAPABILITY IN WIRELESS COMMUNICATION NETWORKS

(71) Applicant: SAMSUNG ELECTRONICS CO., LTD., Suwon-si (KR)

(72) Inventors: Vinay Kumar SHRIVASTAVA, Bangalore (IN); Karthik MURALIDHAR, Bangalore (IN); Diwakar SHARMA, Bangalore (IN)

(21) Appl. No.: 19/452,007

(22) Filed: Jan. 16, 2026

(30) Foreign Application Priority Data
Jan. 16, 2025 (IN) 202541003712
Jan. 29, 2025 (IN) 202541007372
Jan. 31, 2025 (IN) 202541008345
Dec. 29, 2025 (IN) 202541003712

(51) Int. Cl. H04W 76/18; H04L 5/00; H04W 72/30; H04W 72/51; H04W 76/15; H04W 76/27

(52) U.S. Cl. CPC H04W 76/18; H04L 5/0046; H04W 72/51; H04W 76/15; H04W 76/27; H04W 72/30

(57) ABSTRACT

The present disclosure relates to a method, device and system for reporting baseband resource capability of a user equipment (UE) in a wireless communication network, particularly for receiving multimedia broadcast multicast service (MBMS) transmissions. The method includes receiving a signaling message from a serving cell indicating allowed transmission of an MBMS interest indication message, and transmitting this message in response to at least one trigger condition, which may involve reception of a radio resource control (RRC) reconfiguration, execution of a conditional reconfiguration, or detection of a radio link failure. The MBMS interest indication message comprises parameters such as frequency information, sub-carrier spacing, and bandwidth related to receiving 5G broadcast transmissions on a FeMBMS LTE cell.

### CROSS REFERENCE TO RELATED APPLICATIONS

This application is based on and derives the benefit of Indian Provisional Applications IN202541003712 dated Jan. 16, 2025, IN202541007372 dated Jan. 29, 2025, IN202541008345 dated Jan. 31, 2025, and Indian Non-Provisional Application IN202541003712 dated Dec. 29, 2025, the contents of which are incorporated herein by reference.

### BACKGROUND

### 1. Field

The present disclosure relates to field of wireless communication networks, specifically focusing on the reporting of baseband resource capabilities for user equipment (UE) during the reception of multimedia broadcast multicast services (MBMS) in 5^{th} generation(5G)/long term evolution (LTE) environments, particularly in scenarios involving handover, conditional reconfiguration, and radio link failures.

### 2. Description of Related Art

5G mobile communication technologies define broad frequency bands such that high transmission rates and new services are possible and can be implemented not only in “Sub 6 GHz” bands such as 3.5GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadBand (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NRU) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Embodiments of the present disclosure relate to a method for reporting baseband resource capability of a user equipment (UE) in a wireless communication network, which includes receiving, by the UE from a serving cell, a signaling message that indicates allowed transmission of a multimedia broadcast multicast service (MBMS) interest indication message, and subsequently transmitting the MBMS interest indication message to the serving cell in response to receiving the signaling message and at least one trigger condition. The trigger condition comprises at least one of, reception of a radio resource control (RRC) reconfiguration including mobility information for handover, execution of a conditional reconfiguration, or detection of radio link failure followed by RRC connection reestablishment. The MBMS interest indication message includes baseband resource capability reporting parameters required for receiving broadcast transmission. In an embodiment, the UE receives 5G broadcast transmission on a FeMBMS LTE cell.

In an embodiment, the present disclosure relates to a user equipment (UE) for reporting baseband resource capability. The UE includes a memory and a processor, which is configured to receive from a serving cell, a signaling message that indicates allowed transmission of a multimedia broadcast multicast service (MBMS) interest indication message, and subsequently transmitting the MBMS interest indication message to the serving cell in response to receiving the signaling message and at least one trigger condition. The trigger condition comprises at least one of, reception of a radio resource control (RRC) reconfiguration including mobility information for handover, execution of a conditional reconfiguration, or detection of radio link failure followed by RRC connection reestablishment. The MBMS interest indication message includes baseband resource capability reporting parameters required for receiving broadcast transmission. In an embodiment, the UE receives 5G broadcast transmission on a FeMBMS LTE cell.

In some embodiments, the disclosure provides that the baseband resource capability reporting parameters encompass at least one of frequency information, sub-carrier spacing information, or bandwidth information pertinent to the baseband resource capability. Additionally, the signaling message can include one or more of a SystemInformationBlockType15 or an mbms-ROM-ServiceIndication received in SystemInformationBlockType2 indicative of the necessary baseband resource capability reporting parameters for the transmission of the MBMS interest indication message. Moreover, the transmission of the MBMS interest indication message is based on detecting the radio link failure which involves determining the radio link status of the UE with the serving cell. The transmission of the MBMS interest indication message can occur when the UE initiates or transmits the interest and/or assistance signaling message within one second preceding the corresponding trigger condition. Prior to transmitting the MBMS interest indication message, the method can include verifying a valid version of a broadcast/multicast system information block (e.g., SIB15), if present and determining sets of broadcast/multicast frequencies and services of interest. The transmission can be directed to a target cell indicated in the mobility information, using the baseband resource capability report to optimize UE configuration during or after handover.

The foregoing summary is illustrative only and is not intended to be in any way limiting. In addition to the illustrative aspects, embodiments, and features described above, further aspects, embodiments, and features will become apparent by reference to the drawings and the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates a system architecture in accordance with some embodiments of the present disclosure.

FIG. 2 illustrates a UE functionality in accordance with some embodiments of the present disclosure.

FIG. 3 illustrates a RAN architecture in accordance with some embodiments of the present disclosure.

FIG. 4 illustrates a flowchart of the transmission process of an MBMS interest indication message in accordance with some embodiments of the present disclosure.

FIG. 5 illustrates a flowchart for configuring user equipment based on broadcast system information for optimizing unicast parameters in accordance with some embodiments of the present disclosure.

FIG. 6 illustrates a sequence diagram for the transmission of an MBMS interest indication message during RRC connection reconfiguration in accordance with some embodiments of the present disclosure.

FIG. 7 illustrates a sequence diagram for transmitting MBMS interest indication messages during radio link failure scenarios in accordance with some embodiments of the present disclosure.

FIG. 8 illustrates a sequence diagram that illustrates the signaling approach to inform UEs whether they are allowed or not allowed to send the MBS interest indication message, in accordance with some embodiments of the present disclosure.

### DETAILED DESCRIPTION

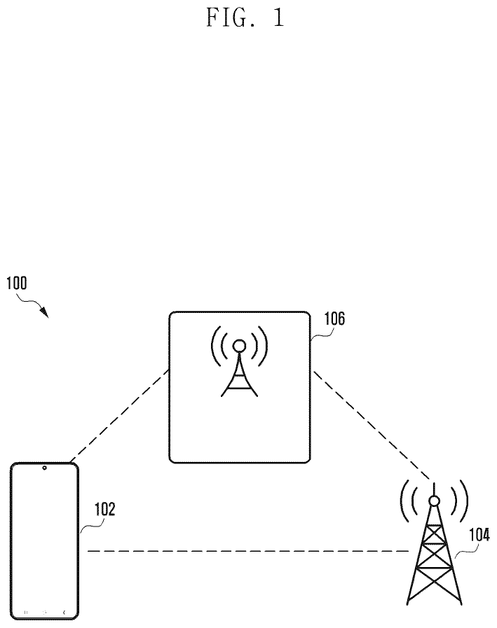

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The field of mobile communications, particularly regarding the implementation of 5G broadcast services, has witnessed significant advancements in recent years, with emphasis on multimedia broadcast multicast services (MBMS) as outlined within the framework of the 3rd generation partnership project (3GPP) standards. These standards aim to facilitate efficient broadcasting capabilities within LTE and 5G networks, enhancing user experience through improved service delivery. Notably, specifications such as TS 36.331 describes protocols governing the interactions between mobile user equipment (UE) and the evolved universal terrestrial radio access network (E-UTRAN), which are crucial for optimizing broadcasting applications. Despite these developments, critical challenges remain unaddressed, particularly in the mechanism for reporting the baseband resource capability of UEs when engaged in 5G broadcast transmission on LTE FeMBMS cells.

5G broadcast (also referred to as further evolved multimedia broadcast multicast service (FeMBMS), receive-only-mode (ROM) or LTE based 5G terrestrial broadcast) is targeted to provide downlink (DL)-only broadcast services to the user equipments (UEs) on a MBMS-dedicated cell with a large coverage area. One typical service use case is enhanced television (EnTV) broadcasting through wireless cellular networks. Further, the MBMS-dedicated cells do not support unicast traffic in the downlink and these cells cannot be used as a primary cell (PCell) or a primary secondary cell (PSCell). System information required to receive MBMS from MBMS-dedicated cells is broadcasted on non-MBSFN sub-frames. The system information change notification as well as earth-quake tsunami warning system (ETWS)/commercial mobile alert service (CMAS) notification are provided via layer 1 (L1) signaling on non-MBSFN sub-frames. The physical broadcast channel (PBCH) of MBMS-dedicated cell, uses a different scrambling sequence initialization than the physical broadcast channel (PBCH) of MBMS/Unicast-mixed cell which prevents UEs not supporting FeMBMS from camping on this cell.

Baseband resource capability report of the UE is carried in the MBMS interest indication message. However, the UE may encounter two scenarios related to RRC connection reconfiguration with mobility control information (termed as, mobilityControlInfo) which may occur during mobility of the UE e.g., handover, and RRC reestablishment which may take place when a radio link failure occurs. In these scenarios, transmission of the MBMS interest indication message carrying the baseband resource capability report of the UE in response to the reception of the 5G broadcast transmission may not be reliable. Moreover, it is possible that the target serving cell (also termed as primary cell or PCell) does not provide SIB15 and therefore, the UE may face an issue that MBMS interest indication message carrying the baseband resource capability report cannot be initiated.

As a consequence, the target cell may not be aware about the baseband resource capability of the UE and the target cell may incorrectly or inappropriately configure the UE with the improper unicast configurations that may degrade the UE performance.

Thus, it is desired to address the mentioned disadvantages or other shortcomings or at least provide a useful alternative.

The information disclosed in this background of the disclosure section is only for enhancement of understanding of the general background of the invention and should not be taken as an acknowledgement or any form of suggestion that this information forms the prior art already known to a person skilled in the art.

Hereinafter, embodiments of the disclosure will be described in detail with reference to the accompanying drawings.

In describing the embodiments, while numerous details are set forth for the purpose of illustration, it is understood that some aspects of the disclosure may be practiced with less than all of these details. Numerous variations and alternatives to the details provided herein are possible and are considered within the scope of the disclosure. In some instances, descriptions related to technical contents well-known in the art may be omitted so as to not obscure an understanding of the disclosure, and such omitted descriptions are understood to be within the scope of the disclosure.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described herein in detail in conjunction with the accompanying drawings. However, the disclosure is not limited to the embodiments set forth herein, but may be implemented in various different forms. Other features, aspects, and advantages of the subject matter described herein will become apparent from the disclosure. The following embodiments are merely examples to aid in an understanding of the disclosure and should not be construed to narrow the scope or spirit of the subject matter described herein in any way, but on the contrary, the disclosure covers all modifications, equivalents and alternatives falling within the spirit and scope of the subject matter as defined by the appended claims and equivalents thereof. Throughout the specification, the same or like reference numerals designate the same or like elements. Furthermore, terms which will be described herein are terms defined in consideration of the functions in the disclosure, and may be different according to users, intentions of the operators, or customs. Therefore, the definitions of the terms should be made based on the contents throughout the specification.

Herein, it will be understood that each block of flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “~unit/module” may refer to a software element or a hardware element, such as a field programmable gate array (FPGA) or an application specific integrated circuit (ASIC), which performs a predetermined function. However, the term including the word “~unit/module” does not always have a meaning limited to software or hardware. The “~unit/module” may be constructed either to be stored in an addressable storage medium or to execute one or more processors. Therefore, the “~unit/module” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “~unit/module” may be either combined into a smaller number of components and a “~unit/module,” or divided into additional components and a “~unit/module.” Moreover, the components and “~units/modules” may be implemented to reproduce one or more central processing units (CPUs) within a device or a security multimedia card. Further, in the embodiments, the “~unit/module” may include one or more processors.

The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in a memory, such as the operating system, in order to control the overall operation of the device. Also, the one processor or the combination of processors is also capable of executing other processes and programs resident in the memory, such as processes for the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program [product] comprising instructions which, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ~,” “second ~,” etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ~” and “second ~” are described in the present disclosure, it may be understood that element(s) referred to by “first ~” and “second ~” may be the same or different. For example, in case of element(s) being information, first information and second information may both be same information and, in some cases, are separate and different information.

In addition, the terms “if ~” and “in case that ~” as used in the disclosure or claims may be interpreted to include the meanings of “when (or upon) ~,” “in response to ~,” “based on ~,” or “according to ~,” and may be used interchangeably with these expressions. In addition, expressions other than those exemplified herein may also be used, as long as they have substantially the same meaning and do not impair the technical features of the present disclosure. If a method step (e.g., transmit a signal) is performed according to the disclosure of the application in connection with one of the above terms (such as “in case that ~” or the like), it may be interpreted to include the meanings (disclosure) of a prior determination that a feature has a specific state “~” (e.g., a bit length is above X), and then perform the method step in response to said determination.

For example, the physical layer signaling may be referred to as layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the embodiments of the present disclosure described herein, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described herein illustrate example methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The process of the flowchart may be performed by a device. One or more of the steps of the flowchart can be implemented by one or more processors/computer programs executing instructions to perform the noted functions.

The methods and apparatuses proposed in the embodiments of the present disclosure may be disclosed in connection with drawings disclosing flowcharts to illustrate example methods that may be implemented according to the principles of the present disclosure. Such flowcharts may contain different branches and/or sub-branches. It is understood that the principles of the present disclosure do not only contain the combination of all branches/sub-branches disclosed in the embodiment, but the present disclosure also contains at least one isolated branch/isolated sub-branch, in particular to a single branch/single sub-branch.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B,” such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described herein, and other terms having equivalent technical meanings may also be used. Such terms may also be interchangeable with terms defined in any 3rd generation partnership project (3GPP) technical specifications (TS) or similar technical specifications, e.g., from the European telecommunications standards institute (ETSI), where appropriate.

Hereinafter, a base station (BS) is an entity that allocates resources to terminals, and may be at least one of a gNode B, an eNode B, a Node B, a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5th generation (5G) base station architectures in which such CU and DU functional splits are implemented.

A terminal may include a user equipment (UE), a mobile station (MS), a cellular phone, a smartphone, a computer, a tablet, a wearable device, an Internet of Things (IoT) device, or any other device/system capable of performing communication functions.

In the disclosure, a downlink (DL) refers to a radio link through which a BS transmits a signal to a terminal, and an uplink (UL) refers to a radio link through which a terminal transmits a signal to a BS.

Furthermore, hereinafter, 5G mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure.

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), RRC, or MAC control element (CE), or a non-access stratum (NAS) signaling message, or an application layer message. The RRC signaling message may be referred to as Layer 3 (L3) signaling.

In addition, L1 signaling may refer to signaling corresponding to at least one or any combination of signaling techniques using the at least one or any combination of the following physical layer channels or signaling: physical downlink control channel (PDCCH), DCI, UE-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

The embodiments herein achieve a method and a system for enabling reception of 5G broadcast transmission.

It is to be noted that the embodiments of the invention may interchangeably use the terms 5G broadcast, FeMBMS, Receive-Only-Mode (ROM) or LTE based 5G terrestrial broadcast or LTE MBMS without any restrictions or limitations.

Accordingly, embodiments herein disclose a method and a system for a reliable reporting of baseband resource capability of the UE in response to the reception of 5G broadcast transmission. Embodiments of the invention disclose a method to report baseband resource capability during radio link failure scenario and RRC connection reconfiguration with mobility control information (mobilityControlInfo) scenario in response to the received signaling which informs UEs that they are allowed for the transmission of MBMS interest indication message carrying the baseband resource capability reporting based on the reception of 5G broadcast transmission from a LTE FeMBMS cell.

One illustration may include the transmission of MBMS interest indication message carrying the baseband resource capability report of the UE in response to the reception of the 5G broadcast transmission in the RRC connection reconfiguration with mobility control information (mobilityControlInfo) scenario, according to embodiments as disclosed herein.

In an embodiment, if mbms-ROM-ServiceIndication is received by the UE in SystemInformationBlockType2 from PCell and if the UE has initiated transmission of a MBMS interest indication message during the last 1 second preceding reception of this RRC connection Reconfiguration message including mobilityControlInfo, or if the RRC Connection Reconfiguration message is applied due to a conditional reconfiguration execution, and the UE supports MBMS reception and the UE has initiated transmission of a MBMS interest indication message since it was configured to do so, the UE initiates transmission of a MBMS interest indication message (comprising the baseband resource capability reporting parameters for 5G broadcast reception on a LTE FeMBMS cell) to the PCell. The baseband resource capability reporting parameters may include at least one of frequency (e.g., mbms-ROM-Freq), sub-carrier spacing information (e.g., mbms-ROM-SubcarrierSpacing), and bandwidth information (e.g., mbms-Bandwidth).

In an embodiment, an example of proposed specification (3GPP TS 36.331) is provided for transmitting by the UE, in the RRCConnectionReconfiguration with mobilityControlInfo scenario or conditional reconfiguration scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

Example 1:
1> if MAC successfully completes the random access procedure; or if MAC indicates the successful reception of a PDCCH transmission addressed to C-RNTI and if rach-Skip is configured:
2> if SystemInformationBlockType15 is broadcast by the PCell; or
2> if mbms-ROM-ServiceIndication is received in SystemInformationBlockType2 from PCell:
3> if the UE has initiated the transmission of a MBMSInterestIndication message during the last 1 second preceding reception of the RRCConnectionReconfiguration message including mobilityControlInfo; or
3> if the RRCConnectionReconfiguration message is applied due to a conditional reconfiguration execution and the UE supports MBMS reception and the UE has initiated transmission of an MBMSInterestIndication message since it was configured to do so in accordance with (3GPP TS 36.331):
4> ensure having a valid version of SystemInformationBlockType15 for the PCell, if present;
4> determine the set of MBMS frequencies of interest in accordance with (3GPP TS 36.331);
4> determine the set of MBMS services of interest in accordance with (3GPP TS 36.331);
4> initiate transmission of the MBMSInterestIndication message in accordance with (3GPP TS 36.331).

In an embodiment, if mbms-ROM-ServiceIndication is received by the UE in SystemInformationBlockType2 from PCell when the UE is receiving or no longer receiving 5G broadcast transmission from LTE FeMBMS cell and if the UE has initiated transmission of a MBMS interest indication message during the last 1 second preceding reception of this RRC connection Reconfiguration message including mobilityControlInfo, or if the RRC Connection Reconfiguration message is applied due to a conditional reconfiguration execution, and the UE supports MBMS reception and the UE has initiated transmission of a MBMS interest indication message since it was configured to do so, the UE initiates transmission of a MBMS interest indication message (comprising the baseband resource capability reporting parameters for 5G broadcast reception on a LTE FeMBMS cell) to the PCell. The baseband resource capability reporting parameters may include at least one of frequency (e.g., mbms-ROM-Freq), sub-carrier spacing information (e.g., mbms-ROM-SubcarrierSpacing), and bandwidth information (e.g., mbms-Bandwidth). Here, no longer receiving 5G broadcast transmission implies a transition for the UE from previously receiving 5G broadcast transmission to the not receiving 5G broadcast transmission. In this case, UE may transmit MBMS interest indication message with empty field(s) for the baseband resource capability reporting parameters. That is, the parameters for the frequency information (e.g., mbms-ROM-Freq), sub-carrier spacing information (e.g., mbms-ROM-SubcarrierSpacing) and bandwidth information (e.g., mbms-Bandwidth) are not included in the baseband resource capability report sent via MBMS interest indication message.

In an embodiment, an example of proposed specification (for 3GPP TS 36.331) is provided for transmitting by the UE in the RRC connection reconfiguration with mobility control information (mobilityControlInfo) scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

Example 2:
1> if MAC successfully completes the random access procedure; or
if MAC indicates the successful reception of a PDCCH transmission addressed to C-RNTI and if rach-Skip is configured:
(omitted text)
2> if SystemInformationBlockType15 is broadcast by the PCell; or
2> if mbms-ROM-ServiceIndication is received in SystemInformationBlockType2 from PCell (when the UE is receiving or no longer receiving 5G broadcast transmission from LTE FeMBMS cell):
3> if the UE has initiated the transmission of a MBMSInterestIndication message during the last 1 second preceding reception of the RRCConnectionReconfiguration message including mobilityControlInfo; or
3> if the RRCConnectionReconfiguration message is applied due to a conditional reconfiguration execution and the UE supports MBMS reception and the UE has initiated transmission of an MBMSInterestIndication message since it was configured to do so in accordance with (3GPP TS 36.331):
4> ensure having a valid version of SystemInformationBlockType15 for the PCell, if present;
4> determine the set of MBMS frequencies of interest in accordance with (3GPP TS 36.331);
4> determine the set of MBMS services of interest in accordance with (3GPP TS 36.331);
4> initiate transmission of the MBMSInterestIndication message in accordance with (3GPP TS 36.331).

Another scenario may include the transmission of MBMS interest indication message carrying the baseband resource capability report of the UE in response to the reception of the 5G broadcast transmission in the RRC reestablishment or radio link failure scenario, according to embodiments as disclosed herein.

In an embodiment, if mbms-ROM-ServiceIndication is provided in SIB2 by the PCell and if the UE has transmitted an MBMS interest indication message during the last 1 second preceding detection of radio link failure, the UE initiates transmission of a MBMS interest indication message (comprising the baseband resource capability reporting parameters) to the PCell. The baseband resource capability reporting parameters may include at least one of frequency (e.g., mbms-ROM-Freq), sub-carrier spacing information (e.g., mbms-ROM-SubcarrierSpacing), and bandwidth information (e.g., mbms-Bandwidth).

In an embodiment, an example of proposed specification (3GPP TS 36.331) is provided for transmitting by the UE in the radio link failure scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

Example 3:

The UE shall:
1> stop timer T301;
1> consider the current cell to be the PCell;
except for a NB-IoT UE for which AS security has not been activated:
(omitted text)
2> if SystemInformationBlockType15 is broadcast by the PCell; or
2> if mbms-ROM-ServiceIndication is received in SystemInformationBlockType2 from PCell:
3> if the UE has transmitted an MBMSInterestIndication message during the last 1 second preceding detection of radio link failure:
4> ensure having a valid version of SystemInformationBlockType15 for the PCell, if present;
4> determine the set of MBMS frequencies of interest in accordance with (3GPP TS 36.331);
4> determine the set of MBMS services of interest in accordance with (3GPP TS 36.331);
4> initiate transmission of the MBMSInterestIndication message in accordance with (3GPP TS 36.331).

In an embodiment, if mbms-ROM-ServiceIndication is provided in SIB2 by the PCell when the UE is receiving or no longer receiving 5G broadcast transmission from LTE FeMBMS cell and if the UE has transmitted an MBMS interest indication message during the last 1 second preceding detection of radio link failure, the UE initiates transmission of a MBMS interest indication message (comprising the baseband resource capability reporting parameters) to the PCell. The baseband resource capability reporting parameters may include at least one of frequency (e.g., mbms-ROM-Freq), sub-carrier spacing information (e.g., mbms-ROM-SubcarrierSpacing), and bandwidth information (e.g., mbms-Bandwidth). Here, no longer receiving 5G broadcast transmission implies a transition for the UE from previously receiving 5G broadcast transmission to the not receiving 5G broadcast transmission. In this case, UE may transmit MBMS interest indication message with empty field(s) for the baseband resource capability reporting parameters. That is, the parameters for the frequency information (e.g., mbms-ROM-Freq), sub-carrier spacing information (e.g., mbms-ROM-SubcarrierSpacing) and bandwidth information (e.g., mbms-Bandwidth) are not included in the baseband resource capability report sent via MBMS interest indication message.

In an embodiment, an example of proposed specification (3GPP TS 36.331) is provided for transmitting by the UE, in the radio link failure scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

Example 4:

The UE shall:
1> stop timer T301;
1> consider the current cell to be the PCell;
except for a NB-IoT UE for which AS security has not been activated:
(omitted text)
2> if SystemInformationBlockType15 is broadcast by the PCell; or
2> if mbms-ROM-ServiceIndication is received in SystemInformationBlockType2 from PCell (when the UE is receiving or no longer receiving 5G broadcast transmission from LTE FeMBMS cell):
3> if the UE has transmitted an MBMSInterestIndication message during the last 1 second preceding detection of radio link failure:
4> ensure having a valid version of SystemInformationBlockType15 for the PCell, if present;
4> determine the set of MBMS frequencies of interest in accordance with (3GPP TS 36.331);
4> determine the set of MBMS services of interest in accordance with (3GPP TS 36.331);
4> initiate transmission of the MBMSInterestIndication message in accordance with (3GPP TS 36.331).

In an embodiment, the UE (not shown) includes a memory, a processor, a communicator, and an innovative hardware such as reliable reporting manager or controller connected to the memory and the processor.

The memory is configured to store instructions to be executed by the processor. The memory can include non-volatile storage elements. Examples of such non-volatile storage elements may include magnetic hard disks, optical discs, floppy disks, flash memories, or forms of electrically programmable memories (EPROM) or electrically erasable and programmable (EEPROM) memories. In addition, the memory may, in some examples, be considered a non-transitory storage medium. The term non-transitory may indicate that the storage medium is not embodied in a carrier wave or a propagated signal. However, the term non-transitory should not be interpreted to mean that the memory is non-movable. In some examples, the memory is configured to store larger amounts of information. In an example, a non-transitory storage medium may store data that can over time change (e.g., in Random Access memory (RAM) or cache).

The processor may include one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). The processor may include multiple cores and is configured to execute the instructions stored in the memory.

The communicator includes an electronic circuit specific to a standard that enables wired or wireless communication. The communicator is configured to communicate internally between internal hardware components of the UE and with external devices via one or more networks.

In an embodiment, the Reliable reporting manager or controller (or any other name is also possible) is an innovative hardware for reliable reporting of baseband resource capability of the UE in response to the reception of 5G broadcast transmission as described above.

The embodiments herein achieve systems and methods of receiving 5G broadcast transmission for multi-mode UE.

Accordingly, embodiments herein disclose systems and methods for receiving 5G broadcast transmission for a multi-mode UE. Embodiments disclose methods and systems for operating HARQ process or processes for reception of 5G broadcast transmissions and determining the baseband resource capability impact on the communication with the 5G NR network. Further, embodiments disclose methods and systems for composing and sending the baseband resource capability report based on reception of 5G broadcast transmission from LTE network to the 5G NR network.

A multi-mode UE is connected to 5G NR network (NW A) for availing unicast and in parallel is availing the 5G broadcast transmission from the LTE network (NW B). Due to UE's engagement on NW B, some part of the UE's baseband resource capability is consumed in receiving 5G broadcast transmissions (e.g., 5G broadcast transmissions may utilize lower sub-carrier spacing (SCS) like 2.5 KHz, 1.25 KHz, 0.37 KHz and correspondingly, large Fast Fourier Transforms (FFTs) are used, Hybrid automatic Repeat Request (HARQ) support may add further processing requirements). Consequently, UE may not be able to offer the full baseband resource capability towards the 5G NR unicast operations (NW A). Since there is no existing baseband resource capability reporting pertaining to 5G broadcast towards the 5G NR network, the 5G NR network is not aware about UE's available baseband resource capability and could not configure the UE properly for the unicast operations (e.g., the number of component carriers in carrier aggregation may be more than what the UE can handle or support, the scheduling rates may not be correctly configured by the NW A for the UE). The invention provides multiple solutions to address these shortcomings and provide solutions that ensure proper configuration for the UE on NW A.

In an embodiment herein, the UE determines the baseband resource capability impact to the 5G NR network and reports the associated parameters to the 5G NR network. The parameters may include at least one of the bandwidth used for 5G broadcast, sub-carrier spacing used for 5G broadcast reception, and frequency or carrier used for 5G broadcast reception for one or more services/sessions over one or more cells (e.g., dedicated MBMS cell(s)) where UE is receiving 5G broadcast transmissions and one or more scaling factors based on the SCS used for the reception of 5G broadcast transmission. Further, the 5G broadcast transmission for one or more services and/or for one or more cells may be received Time-division Multiplexed manner (e.g., employing different sub-carrier spacings). In an embodiment, the determination and reporting of baseband resource capability that is impacted/changed due to reception of 5G broadcast transmission is performed only when the UE is in RRC_CONNECTED state with the 5G NR network. That is, the determination and reporting of baseband resource capability to the 5G NR network due to reception of 5G broadcast transmission is not performed when the UE is in one of RRC_IDLE or RRC_INACTIVE state with the 5G NR network.

In an embodiment, the UE may indicate the support or the capability for the reception of 5G broadcast transmission and/or one or more related parameters for the reception of 5G broadcast transmission to the 5G NR network in at least one of the UE capability message, UE assistance information message, RRC connection setup, RRC connection setup complete, RRC resume, multicast broadcast service (MBS) interest indication message.

In an embodiment herein, UE includes at least one parameter pertaining to the reporting of baseband resource capability that is impacted to 5G NR due to reception of 5G broadcast transmission in the MBS interest indication (MII) message and sends the message as the unicast RRC signaling in the uplink direction to the 5G NR network. The parameters may include at least one of the bandwidth used for 5G broadcast, sub-carrier spacing used for 5G broadcast reception, frequency or carrier used for 5G broadcast reception on one or more cells (e.g., dedicated MBMS cell(s)) where UE is receiving 5G broadcast transmissions and one or more scaling factors (e.g., based on the SCS) used for the reception of 5G broadcast transmission.

In an embodiment herein, UE triggers the transmission of the MBS interest indication (MII) message including at least one parameter pertaining to the reporting of baseband resource capability impact to 5G NR due to reception of 5G broadcast transmission from LTE network when there is at least one event is detected for the change of the baseband resource capability and/or the change of at least one parameter pertaining to the reporting of baseband resource capability and/or start of at least one 5G broadcast service and/or stop of at least one 5G broadcast service on the LTE network. The UE may be at least in one of RRC_IDLE, RRC_INACTIVE, or RRC_CONNECTED state to the LTE network.

In an embodiment, at least one event is detected for the change of the baseband resource capability and/or the change of at least one parameter pertaining to the reporting of baseband resource capability. The at least one event may comprise at least one of sub-carrier spacing or bandwidth parameter of reception of 5G broadcast transmission has changed since the last transmission of the MII message or set of MBMS frequencies of interest for reception of 5G broadcast transmission has changed since the last transmission of the MII message or entering or leaving the service area of the 5G broadcast transmission.

In an embodiment, UE includes at least one parameter in the MBS interest indication message pertaining to the reporting of baseband resource capability that is impacted to 5G NR due to reception of 5G broadcast transmission only when at least one event is detected for the UE on the LTE network (i.e., for 5G broadcast). That is, if MBS interest indication message transmission is triggered only due to at least one event for the UE on the 5G NR network (e.g., for 5G MBS reception), UE does not include any parameter in the MBS interest indication message pertaining to the reporting of baseband resource capability impact to 5G NR due to reception of 5G broadcast transmission.

In an embodiment, if MBS interest indication message transmission is triggered only due to at least one event for the UE on the 5G NR network (e.g., for 5G MBS reception), the UE may include the previously reported parameters in the MBS interest indication message pertaining to the reporting of baseband resource capability impact to 5G NR due to reception of 5G broadcast transmission. That is, the 5G broadcast related parameters are unchanged (i.e., just repeated) in the transmitted MBS interest indication message.

In an embodiment herein, if MBS interest indication message transmission is triggered only due to at least one event for the UE on the LTE network (i.e., for 5G broadcast), the UE may only include at least one parameter in the MBS interest indication message pertaining to the reporting of baseband resource capability impact to 5G NR due to reception of 5G broadcast transmission.

In an embodiment herein, if MBS interest indication message transmission is triggered due to both of at least one event for the UE on the LTE network (i.e., for 5G broadcast) and at least one event for the UE on 5G NR network (e.g., for 5G MBS reception), the UE may include at least one parameter in the MBS interest indication message pertaining to the reporting of baseband resource capability impact to 5G NR caused by the reception of 5G broadcast transmission and at least one parameters pertaining to the 5G MBS reception.

In an embodiment herein, UE adds at least one instance for 5GB MBMS interest indication (MII) parameters (or Receive-Only-Mode (ROM) MBMS interest indication parameters) in the NR MBS MII message in order to convey the baseband resource capability reporting due to receiving the 5G broadcast transmission on the LTE network and is reported to the 5G NR network.

In an embodiment herein, an example of NR MBS interest indication message to the 5G NR network is provided that carries the at least one parameter for the baseband resource capability reporting due to receiving the 5G broadcast transmission on the LTE network as follows:

Example 5:

MBSInterestIndication-r17 ::= SEQUENCE {

| | |
|---|---|
| criticalExtensions | CHOICE { |
| mbsInterestIndication-r17 | MBSInterestIndication-r17-IEs, |
| criticalExtensionsFuture | SEQUENCE { } |

}
}
MBSInterestIndication-r17-IEs ::= SEQUENCE {

| | | |
|---|---|---|
| mbs-FreqList-r17 | CarrierFreqListMBS-r17 | OPTIONAL, |
| mbs-Priority-r17 | ENUMERATED {true} | OPTIONAL, |
| mbs-ServiceList-r17 | MBS-ServiceList-r17 | OPTIONAL, |
| lateNonCriticalExtension | OCTET STRING | OPTIONAL, |
| nonCriticalExtension | MBSInterestIndication-v1800 | OPTIONAL |

}
MBSInterestIndication-v1800 ::= SEQUENCE {

| | | |
|---|---|---|
| mbs-NonServingInfoList-r18 | MBS-NonServingInfoList-r18 | OPTIONAL, |
| nonCriticalExtension | MBSInterestIndication-v1900 | OPTIONAL |

}
MBSInterestIndication-v1900 ::= SEQUENCE {

| | |
|---|---|
| 5G-BroadcastInfoList-r19 | 5G-BroadcastInfoList-r19 |

OPTIONAL,

| | | |
|---|---|---|
| nonCriticalExtension | SEQUENCE { } | OPTIONAL |

}

| | |
|---|---|
| 5G-BroadcastInfoList-r19 | SEQUENCE (SIZE(1...maxMBMS-ServiceListPerUE)) OF 5G- |

Broadcast-Info-r19
5G-Broadcast-Info-r19 ::= SEQUENCE {

| | |
|---|---|
| 5G-Broadcast-Freq-r19 | ARFCN-ValueEUTRA-r9, |

| | |
|---|---|
| 5G-Broadcast-SubcarrierSpacing-r19 | ENUMERATED {kHz15, kHz7dot5, |

kHz1dot25,kHz2dot5, kHz0dot37},

| | |
|---|---|
| 5G-Broadcast-Bandwidth-r19 | ENUMERATED {n6, n15, |

n25, n50, n75, n100}
}

In an embodiment, the NR MBS parameters in the MBS interest indication message are reused to accommodate and convey information for the 5G broadcast transmission. For example, cfr-Bandwidth is reused to convey 5G-Broadcast-Bandwidth, subcarrierSpacing is reused to convey 5G-Broadcast-SubcarrierSpacing, and carrierFreqMBS is reused to convey ARFCN-ValueEUTRA. Further, scaling factors used by the UE for the reception 5G broadcast transmission may be explicitly or implicitly may be included in the MBS interest indication message. Further, the scaling factors conveyed in the NR MII message may be same or different than the scaling factors as compared to that used for LTE network. An example of NR MBS interest indication message is provided as follows:

Example 6:

MBSInterestIndication-r17 ::= SEQUENCE {

| | |
|---|---|
| criticalExtensions | CHOICE { |
| mbsInterestIndication-r17 | MBSInterestIndication-r17-IEs, |
| criticalExtensionsFuture | SEQUENCE { } |

}
}
MBSInterestIndication-r17-IEs ::= SEQUENCE {

| | | |
|---|---|---|
| mbs-FreqList-r17 | CarrierFreqListMBS-r17 | OPTIONAL, |
| mbs-Priority-r17 | ENUMERATED {true} | OPTIONAL, |
| mbs-ServiceList-r17 | MBS-ServiceList-r17 | OPTIONAL, |
| lateNonCriticalExtension | OCTET STRING | OPTIONAL, |
| nonCriticalExtension | MBSInterestIndication-v1800 | OPTIONAL |

}
MBSInterestIndication-v1800 ::= SEQUENCE {

| | | |
|---|---|---|
| mbs-NonServingInfoList-r18 | MBS-NonServingInfoList-r18 | OPTIONAL, |

}

| | |
|---|---|
| MBS-NonServingInfoList-r18 ::= | SEQUENCE (SIZE (1..maxFreqMBS-r17)) OF |

NonServingInfo-r18

| NonServingInfo-r18 ::= | SEQUENCE { | |
|---|---|---|
| freqInfoMBS-r18 | FreqInfoMBS-r18 | OPTIONAL, |

| | |
|---|---|
| cfr-InfoMBS-r18 | CHOICE { |
| cfr-Bandwidth-r18 | 5G-Broadcast-Bandwidth-r19, |
| } | OPTIONAL, |
| subcarrierSpacing-r18 | 5G-Broadcast-SubcarrierSpacing-r19 |

OPTIONAL
}

| | |
|---|---|
| FreqInfoMBS-r18 ::= | SEQUENCE { |
| carrierFreqMBS-r18 | ARFCN-ValueEUTRA-r9, |

}
}

In an embodiment, embedded signaling (also termed as LTE-container or transparent signaling) for LTE MBMS interest indication (i.e., the octet string for the MBMSInterestIndication message) is carried in the NR MBS interest indication message and is reported to the 5G NR network. MBMSInterestIndication may consist of information for at least on LTE frequency, bandwidth and sub-carrier spacing used for reception of 5G broadcast transmission on the LTE network. An example of NR MBS interest indication message is provided follows:

Example 7:

MBSInterestIndication-r17 ::= SEQUENCE {

| | |
|---|---|
| criticalExtensions | CHOICE { |
| mbsInterestIndication-r17 | MBSInterestIndication-r17-IEs, |
| criticalExtensionsFuture | SEQUENCE { } |

}
}
MBSInterestIndication-r17-IEs ::= SEQUENCE {

| | | |
|---|---|---|
| mbs-FreqList-r17 | CarrierFreqListMBS-r17 | OPTIONAL, |
| mbs-Priority-r17 | ENUMERATED {true} | OPTIONAL, |
| mbs-ServiceList-r17 | MBS-ServiceList-r17 | OPTIONAL, |
| lateNonCriticalExtension | OCTET STRING | OPTIONAL, |
| nonCriticalExtension | MBSInterestIndication-v1800 | OPTIONAL |

}
MBSInterestIndication-v1800 ::= SEQUENCE {

| | | |
|---|---|---|
| mbs-NonServingInfoList-r18 | MBS-NonServingInfoList-r18 | OPTIONAL, |
| nonCriticalExtension | MBSInterestIndication-v1900 | OPTIONAL |

}
MBSInterestIndication-v1900 ::= SEQUENCE {

| | | |
|---|---|---|
| MBMSInterestIndication | OCTET STRING | OPTIONAL, |

OPTIONAL,

| | | |
|---|---|---|
| nonCriticalExtension | SEQUENCE { } | OPTIONAL |

}

In an embodiment herein, embedded signaling (also termed as LTE-container or transparent signaling) for at least one instance of ROM parameters (i.e., the octet string for the mbms-ROM-InfoList message) is carried in the NR MBS interest indication message and is reported to the 5G NR network. mbms-ROM-InfoList may consist of information for at least on LTE frequency, bandwidth and sub-carrier spacing used for reception of 5G broadcast transmission on the LTE network. An example of NR MBS interest indication message is provided as follows:

Example 8:

| | |
|---|---|
| MBSInterestIndication-r17::= | SEQUENCE { |
| criticalExtensions | CHOICE { |
| mbsInterestIndication-r17 | MBSInterestIndication-r17-IEs, |
| criticalExtensionsFuture | SEQUENCE { } |

}
}
MBSInterestIndication-r17-IEs ::= SEQUENCE {

| | | |
|---|---|---|
| mbs-FreqList-r17 | CarrierFreqListMBS-r17 | OPTIONAL, |
| mbs-Priority-r17 | ENUMERATED {true} | OPTIONAL, |
| mbs-ServiceList-r17 | MBS-ServiceList-r17 | OPTIONAL, |
| lateNonCriticalExtension | OCTET STRING | OPTIONAL, |
| nonCriticalExtension | MBSInterestIndication-v1800 | OPTIONAL |

}
MBSInterestIndication-v1800 ::= SEQUENCE {

| | | |
|---|---|---|
| mbs-NonServingInfoList-r18 | MBS-NonServingInfoList-r18 | OPTIONAL, |
| nonCriticalExtension | MBSInterestIndication-v1900 | OPTIONAL |

}
MBSInterestIndication-v1900 ::= SEQUENCE {

| | | |
|---|---|---|
| mbms-ROM-InfoList | OCTET STRING | OPTIONAL, |

OPTIONAL,

| | | |
|---|---|---|
| nonCriticalExtension | SEQUENCE { } | OPTIONAL |

}

In an embodiment, the scaling factors that are at least one of configured or pre-specified for the UE implementation and/or utilized in the calculation of the achievable throughput for the 5G NR network or impact to the baseband resource capability impact to the 5G NR and/or reported in the MBS interest indication message to the 5G NR network may be an at least one of altered, scaled or moderated value of the scaling factors defined/specified /onfigured for that of the LTE network. In another embodiment, the range of scaling factors utilized for the 5G NR network is expanded or modified as compared to that used for the LTE network.

In an embodiment, scaling factors for reception of 5G broadcast transmission and/or maximum bandwidth and/or supported band information for reception of 5G broadcast transmission are conveyed by the UE to the 5G NR network in the UE NR capability information message. An example for this signaling is provided as follows, without limiting the range and actual values of the parameters that are signaled:

Example 9:

| | |
|---|---|
| 5G-Broadcast -Parameters-v19 ::= | SEQUENCE { |
| 5G-Broadcast-MaxBW-r19 | CHOICE { |
| implicitValue | NULL, |
| explicitValue | INTEGER(2..20) |

},

| | |
|---|---|
| 5G-Broadcast-ScalingFactor1dot25-r19 | ENUMERATED {n3, n6, n9, n12} |

OPTIONAL,

| | |
|---|---|
| 5G-Broadcast -ScalingFactor7dot5-r19 | ENUMERATED {n1, n2, n3, n4} |

OPTIONAL
}

| | |
|---|---|
| 5G-Broadcast -ScalingFactor2dot5-r19 | ENUMERATED {n2, n4, n6, n8} |

OPTIONAL,

| | |
|---|---|
| 5G-Broadcast -ScalingFactor0dot37-r19 | ENUMERATED {n12, n16, n20, n24} |

OPTIONAL,

| | |
|---|---|
| 5G-Broadcast -SupportedBandInfoList-r19 | SEQUENCE (SIZE (1..maxBands)) |

OF 5G-Broadcast -SupportedBandInfo-r19
}

In an embodiment, the MBS interest Indication message is triggered and transmitted to the 5G NR network upon the complete loss of the reception of the 5G broadcast transmission on the LTE network (e.g., complete stopping of reception of 5G broadcast transmission by the UE). In this case, the UE includes at least one of empty MBS interest indication message or an empty instance of 5G-broadcast baseband resource capability reporting (e.g., no parameters is included) or an empty instance of ROM parameters (e.g., no parameters is included) or an empty embedded LTE signaling (e.g., zero byte) in the MBS interest indication message. In another embodiment, a special indication as a field or a flag or a bitmap or a default value for at least one parameter is included in MBS interest indication message to convey the complete loss of the reception of the 5G broadcast transmission on the LTE network.

In an embodiment, the MBS interest Indication message is triggered and transmitted to the 5G NR network upon the complete loss of the interest in the reception of the 5G broadcast transmission on the LTE network. In this case, the UE includes at least one of empty MBS interest indication message or an empty instance of 5G-broadcast baseband resource capability reporting (e.g., no parameters is included) or an empty instance of ROM parameters (e.g., no parameters is included) or an empty embedded LTE signaling (e.g., zero byte) in the MBS interest indication message. In another embodiment, a special indication as a field or a flag or a bitmap or a default value for at least one parameter is included in MBS interest indication message to convey the complete loss of interest in the reception of the 5G broadcast transmission on the LTE network.

In an embodiment, the MBS interest Indication message is triggered and transmitted to the 5G NR network upon the loss of coverage of one or more cells providing the 5G broadcast transmission on the LTE network. In this case, the UE includes at least one of empty MBS interest indication message or an empty instance of 5G-broadcast baseband resource capability reporting (e.g., no parameters is included) or an empty instance of ROM parameters (e.g., no parameters is included) or an empty embedded LTE signaling (e.g., zero byte) in the MBS interest indication message. In another embodiment, a special indication as a field or a flag or a bitmap or a default value for at least one parameter is included in MBS interest indication message to convey the loss of coverage for the reception of the 5G broadcast transmission on the LTE network.

In an embodiment, the MBS interest indication is triggered and reported to the 5G NR network when the baseband resource capability caused due to 5G broadcast reception is altered by a threshold quantity. The threshold can be one of configured parameter by the network in a system information block (SIB) or a RRC signaling message, or the threshold can be determined by the UE implementation itself or is a parameter which is specified e.g., in the standards.

In an embodiment, the UE derives, estimates, or calculates a parameter termed as implementation factor (or I-factor) for the reception of the 5G broadcast transmission, which is based on the UE hardware configuration or implementation aspects that will decide how much scaling or moderation is needed for the UE's processing capability. The I-factor can be based on the hardware components that are shared across unicast and broadcast reception paths, utilization for MIMO or multiple frequencies based configurations, implementation aspects in terms of processing power, RF capability, DFT/FFT sizes, memory etc. The I-factor can help the UE to properly scale or moderate the UE's processing capability for the 5G broadcast reception and/or UE's actual processing capability for unicast reception. The I-factor can be communicated to the network in the uplink signaling, which may include at least one of UE capability information message, UE assistance information message, RRC setup complete message or MBS interest indication message. For example, if the I-factor is static quantity or parameter, it may be reported in at least one of the UE capability information message or RRC setup complete message. If the I-factor is a dynamic quantity or parameter, it may be reported in at least one of the UE assistance information message or MBS interest indication message.

In an embodiment, the UE may locally adapt/adjust the UE's actual processing capability based on the derived I-factor for the reception of 5G broadcast transmission and report the updated the UE's actual processing capability; i.e., the UE does not explicitly report the I-factor to the network.

In an embodiment, the UE reports the I-factor for the reception of 5G broadcast transmission to the network. The network then adapts/adjusts the UE's actual processing capability which may be dynamically received from the UE with the reported I-factor. Accordingly, the network calculates the updated UE actual processing capability in order to assess the performance achievable and suitable configuration to be applied to the UE.

In an embodiment, UE sends at least one of the indicators to NW A (5G NR network) in response to reception of 5G broadcast transmission on NW B (LTE) e.g., the indicators may pertain to FFT sizes or processing requirements, HARQ buffer or processing needs, number of carriers, bandwidth etc.

In an embodiment, UE sends scheduling or configuration preferences to NW A (5G NR network) in response to reception of 5G broadcast transmission on NW B (LTE). The scheduling preferences are based on at least one of the indicators pertaining to the reception of 5G broadcast transmission e.g., the indicators may pertain to FFT sizes or processing requirements, HARQ buffer or processing needs, number of carriers, bandwidth etc.

In an embodiment, UE may include at least one of the parameters in the MBS interest indication message to the 5G NR network in response to reception of the 5G broadcast transmission on NW B including but not limited to frequencies or EARFCNs, frequency band, bandwidth, bandwidth part (BWP) configuration, sub-carrier spacing (SCS), TMGI or MBS session ID, a number of physical resource blocks (PRBs), a number of Tx and/or Rx links/paths, a size of DFTs/FFTs used on NW B, MIMO layers utilized, a number of HARQ processes used for the NW B and/or number of available HARQ processes available for NW A, classifier for different MBMS services (e.g., broadcast, FTA, ROM, multicast), radio access technology (RAT) on NW B (e.g., LTE, NR), priorities for service(s), operator name or information, preferred DRX configuration or scheduling on NW A, power consumption or battery status, Scheduling rates or data rates of UE's interested or receiving services on NW B, Number of HARQ Processes used for receiving 5G broadcast transmission on NW B, and Number of available HARQ Processes used for data reception on NW A.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe systems and methods of receiving 5G broadcast transmission for a multi-mode UE. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The network entity in the embodiments disclosed can be 5G network or 6G network.

The embodiments herein achieve a method and a system for enabling reception of 5G broadcast transmission.

Accordingly, embodiments herein disclose a method for enabling reception of 5G broadcast transmission. Embodiments provides a signaling method for informing UEs over a cell whether they are allowed or not allowed to send the MBS interest indication message carrying the baseband resource capability report based on reception of 5G broadcast transmission from LTE FeMBMS cell, to the 5G NR network.

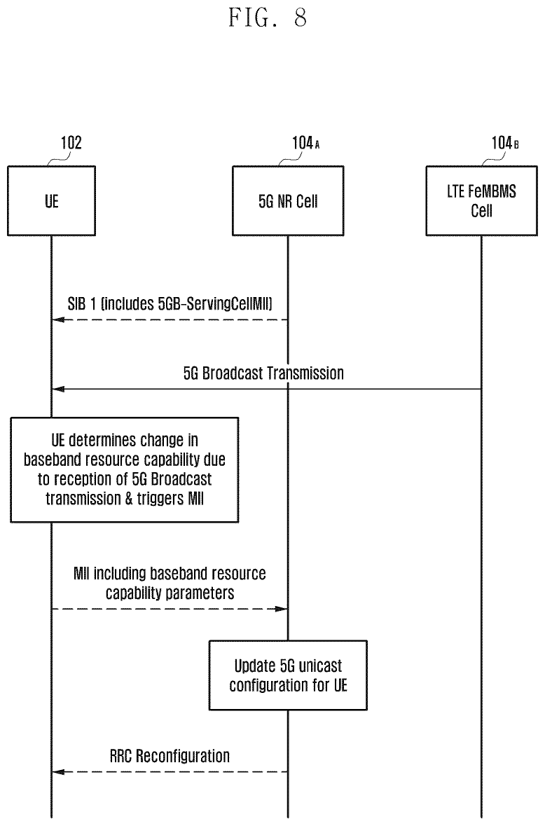

FIG. 8 illustrate the signaling approach to inform UEs whether they are allowed or not allowed to send the MBS interest indication message carrying the baseband resource capability report based on reception of 5G broadcast transmission from LTE FeMBMS cell, to the 5G NR network, according to embodiments as disclosed herein.

A UE may be connected to 5G NR network (NW A) for availing unicast and in parallel may be availing the 5G broadcast transmission from the LTE network (NW B). Due to UE's engagement on NW B, some part of the UE's baseband resource capability is consumed in receiving 5G broadcast transmissions (e.g., 5G broadcast transmissions may utilize lower sub-carrier spacing (SCS) like 2.5 KHz, 1.25 KHz, 0.37 KHz and correspondingly, large fast Fourier transforms (FFTs) are used, hybrid automatic repeat request (HARQ) support may add further processing requirements). Consequently, UE may not be able to offer the full baseband resource capability towards the 5G NR unicast operations (NW A). Since there is no existing baseband resource capability reporting pertaining to 5G broadcast towards the 5G NR network, the 5G NR network is not aware about UE's available baseband resource capability and could not configure the UE properly for the unicast operations (e.g., the number of component carriers in carrier aggregation may be more than what the UE can handle or support, the scheduling rates may not be correctly configured by the NW A for the UE). However, there is a need for a controlled mechanism in case UEs are to be enabled for reporting baseband resource capability report to the 5G NR network, so as to avoid any excessive or undesired reporting and associated drawbacks. The invention provides solutions to address these shortcomings.

In an embodiment, a system information block (SIB) carries at least one parameter that conveys to the UEs in a 5G NR cell, whether the MBS interest indication message carrying the baseband resource capability reporting for 5G broadcast reception on a FeMBMS cell (i.e., LTE cell) is allowed to be transmitted to the serving gNB (i.e., to the 5G NR network).

In an embodiment, the at least one parameter indicating whether the MBS interest indication message carrying the baseband resource capability reporting for 5G broadcast reception on a FeMBMS cell (i.e., LTE cell) is allowed to be transmitted to the serving gNB may be termed as 5GB-ServingCellMII (or mbms-ROM-ServiceIndication or 5GB-ServiceIndication or 5GB-nonServing CellMII). In the invention description, 5GB-ServingCellMII or mbms-ROM-ServiceIndication or 5GB-ServiceIndication or 5GB-nonServingCellMII may be used interchangeably. The parameter may be configured and/or set to be TRUE to indicate allowing of sending MBS interest indication message carrying the baseband resource capability reporting for 5G broadcast reception. The parameter may not be configured (i.e., absent) or be configured and set as FALSE to indicate not allowing of sending MBS interest indication message carrying the baseband resource capability reporting for 5G broadcast reception.

In an embodiment, the parameter 5GB-ServingCellMII may be distinct and separate from the existing parameter nonServingCellMII, wherein nonServingCellMII indicates whether the MBS interest indication message for MBS broadcast reception on a non-serving cell is allowed to be transmitted to the serving gNB.

In an embodiment, the existing parameter nonServingCellMII is reused to also indicate whether the MBS interest indication message carrying the baseband resource capability reporting for 5G broadcast reception on a FeMBMS cell (i.e., LTE cell) is allowed to be transmitted to the serving gNB (i.e., to the 5G NR network). Further, the non-serving cell may also include LTE FeMBMS cell from where UE is receiving 5G broadcast transmission.

In an embodiment, the system information block carrying the parameter 5GB-ServingCellMII may a system information block index 1 (SIB1).

In an embodiment, the system information block carrying the parameter 5GB-ServingCellMII may a system information block index 2 (SIB2).

In an embodiment, the system information block carrying the parameter 5GB-ServingCellMII may a system information block index 20 (SIB20).

In an embodiment, the system information block carrying the parameter 5GB-ServingCellMII may a system information block index 21 (SIB21).

In an embodiment, the system information block carrying the parameter 5GB-ServingCellMII may a new SIB (i.e., SIBx).

In an embodiment, only 5G broadcast capable UE may be allowed to respond with the MBS interest indication message carrying the baseband resource capability reporting for 5G broadcast reception on a FeMBMS cell (i.e., LTE cell) to the serving gNB (i.e., to the 5G NR network).

In an embodiment, the 5G broadcast capable UE need not be an MBS capable. That is, a non-MBS capable UE can also send the MBS interest indication message carrying the baseband resource capability reporting for 5G broadcast reception on a FeMBMS cell (i.e., LTE cell) to the serving gNB (i.e., to the 5G NR network).

In an embodiment, the UE initiates the procedure for transmitting the MBS interest indication message carrying the baseband resource capability reporting for 5G broadcast reception on a FeMBMS cell (i.e., LTE cell) to the serving gNB (i.e., to the 5G NR network) upon change to a Primary Cell (PCell) providing 5GB-ServingCellMII (for example, in SIB1).

In an embodiment, the UE initiates the procedure for transmitting the MBS interest indication message carrying the baseband resource capability reporting for 5G broadcast reception on a FeMBMS cell (i.e., LTE cell) to the serving gNB (i.e., to the 5G NR network) upon change of at least one of a bandwidth information (e.g., mbms-Bandwidth), or frequency (e.g., mbms-ROM-Freq) or subcarrier spacing (e.g., mbms-ROM-SubcarrierSpacing) for 5G broadcast reception on a LTE FeMBMS cell.

In an embodiment, the UE initiates the procedure for transmitting the MBS interest indication message carrying the baseband resource capability reporting for 5G broadcast reception on a FeMBMS cell (i.e., LTE cell) to the serving gNB (i.e., to the 5G NR network) upon change of at least one of a usage or non-usage of time interleaving, frequency interleaving or a combination of time-frequency interleaving.

In an embodiment, the UE initiates the procedure for transmitting the MBS interest indication message carrying the baseband resource capability reporting for 5G broadcast reception on a FeMBMS cell (i.e., LTE cell) to the serving gNB (i.e., to the 5G NR network) upon entering or leaving the 5G broadcast service area or coverage (e.g., a LTE FeMBMS cell or cell-group).

In an embodiment, if the UE does not have the Bandwidth information and subcarrier spacing for 5G broadcast reception on a LTE FeMBMS cell at the time it sends the MBS interest indication, the UE sends another MBS interest indication after it has acquired this information from the LTE FeMBMS cell.

In an embodiment, the UE initiates the procedure for transmitting the MBS interest indication message carrying the empty (i.e., without any parameters included) baseband resource capability reporting for 5G broadcast reception on a FeMBMS cell (i.e., LTE cell) to the serving gNB (i.e., to the 5G NR network), when the UE is no longer receiving the 5G broadcast transmission. That is, when there is a transition for the UE from receiving 5G broadcast transmission to not receiving 5G broadcast transmission, UE initiates the procedure for transmitting the MBS interest indication message carrying the empty baseband resource capability reporting for 5G broadcast reception to the 5G NR network.

In an embodiment, an example of specification is provided as follows that illustrates the triggers for the transmission for the MBS interest indication message carrying the baseband resource capability reporting for 5G broadcast reception on a FeMBMS cell (i.e., LTE cell) to the serving gNB (i.e., to the 5G NR network).

Example 10:

An MBS capable or 5G broadcast capable UE in RRC_CONNECTED may initiate the procedure in several cases including upon successful connection establishment/resume, upon entering or leaving the broadcast service area, upon MBS broadcast session start or stop, upon change of interest, upon change of priority between MBS broadcast reception and unicast/multicast reception, upon change to a PCell providing SIB21 (i.e., where the SIB1 scheduling information contains SIB21), upon receiving SIB20 of an SCell via dedicated signalling, upon handover, and upon RRC connection re-establishment, upon change to a PCell providing nonServingCellMII in SIB1, upon starting or stopping reception of MBS broadcast service on a non-serving cell, upon change of CFR information or subcarrier spacing for MBS broadcast reception on a non-serving cell, upon change to a PCell providing 5GB-ServingCellMII in SIB1, upon starting or stopping reception of 5G broadcast service on a LTE FeMBMS cell, upon change of bandwidth information or frequency or subcarrier spacing for 5G broadcast reception on a LTE FeMBMS cell. If the UE does not have the CFR information and subcarrier spacing for MBS broadcast reception on a non-serving cell at the time it sends the MBS interest indication, the UE sends another MBS interest indication after it has acquired this information from the non-serving cell. If the UE does not have the Bandwidth information and subcarrier spacing for 5G broadcast reception on a LTE FeMBMS cell at the time it sends the MBS interest indication, the UE sends another MBS interest indication after it has acquired this information from the LTE FeMBMS cell.

In an embodiment, an example of specification is provided to illustrate the procedural details for the transmission for the MBS interest indication message carrying the baseband resource capability reporting for 5G broadcast reception on a FeMBMS cell (i.e., LTE cell) to the serving gNB (i.e., to the 5G NR network).

Example 11:

Upon initiating the procedure, the UE shall:
1> if SIB21 is provided by the PCell; or
1> if non-ServingCellMII or 5GB-ServingCellMII is provided in SIB1 by the PCell:
2> ensure having a valid version of SIB21 for the PCell, if present;
2> if the UE did not transmit MBS interest indication since last entering RRC_CONNECTED state; or
2> if SIB21 is provided and since the last time the UE transmitted an MBS interest indication to a PCell providing SIB21, the UE connected to a PCell, not providing SIB21; or
2> If nonServingCellMII or 5GB-ServingCellMII is provided in SIB1 and since the last time the UE transmitted an MBS interest indication to a PCell providing nonServingCellMII or 5GB-ServingCellMII in SIB1, the UE connected to a PCell not providing nonServingCellMII or 5GB-ServingCellMII in SIB1:
3> if the set of MBS broadcast frequencies of interest, determined in accordance with (3GPP TS 36.331), is not empty:
3> if the set of 5G broadcast frequencies of interest, determined in accordance with (3GPP TS 36.331), is not empty:
4> set the contents of MBS interest indication according with (3GPP TS 36.331) and initiate transmission of the MBSInterestIndication message;
2> else:
3> if the set of MBS broadcast frequencies of interest, determined in accordance with (3GPP TS 36.331), is different from mbs-FreqList included in the last transmission of the MBS interest indication; or
3> if the set of MBS broadcast frequencies of interest for MBS broadcast reception on non-serving cell, determined in accordance with (3GPP TS 36.331), is different from freqInfoMBS included in the last transmission of the MBS interest indication; or
3> if any of the subcarrier spacing and the CFR information for MBS broadcast reception on non-serving cell has changed since the last transmission of the MBS interest indication; or
3> if the subcarrier spacing and the CFR information for MBS broadcast reception on non-serving cell have been acquired from the non-serving cell which were not reported in the previous MBS interest indication; or
3> if the set of 5G broadcast frequencies of interest for 5G broadcast reception on LTE FeMBMS cell, determined in accordance with (3GPP TS 36.331), is different from 5GB-freqInfo included in the last transmission of the MBS interest indication; or
3> if any of the subcarrier spacing and the bandwidth information for MBS broadcast reception on LTE FeMBMS cell has changed since the last transmission of the MBS interest indication; or
3> if the subcarrier spacing and the bandwidth information for 5G broadcast reception on LTE FeMBMS cell have been acquired from the LTE FeMBMS cell which were not reported in the previous MBS interest indication; or
3> if the prioritisation of reception of all indicated MBS broadcast frequencies compared to reception of any of the established unicast bearers and multicast MRBs has changed since the last transmission of the MBS interest indication:
4> set the contents of MBS interest indication according to (3GPP TS 36.331) and initiate transmission of the MBSInterestIndication message;
NOTE: The UE may send MBS interest indication even when it is able to receive the MBS services or 5GB broadcast services it is interested in, i.e., to avoid that the network allocates a configuration inhibiting MBS broadcast or 5GB broadcast reception.
3> else if SIB20 is provided for the PCell or for the SCell:
4> if since the last time the UE transmitted the MBS interest indication, the UE connected to a PCell not providing SIB20 and the UE was not provided with SIB20 for an SCell; or
4> if the set of MBS broadcast services of interest determined in accordance with (3GPP TS 36.331) is different from mbs-ServiceList included in the last transmission of the MBS interest indication:
5> set the contents of MBS interest indication according to (3GPP TS 36.331) and initiate the transmission of MBSInterestIndication message.
In an embodiment, if the UE is receiving 5G broadcast service on LTE FeMBMS cell, the UE considers the frequency for the 5G broadcast reception as part of the frequencies of interest for the MBS interest indication message to be reported to the 5G NR network.

In an embodiment, an example of specification (3GPP TS 38.331) is provided for determining the frequencies of interest for the MBS interest indication message carrying the baseband resource capability reporting for 5G broadcast reception on a FeMBMS cell (i.e., LTE cell) to the serving gNB (i.e., to the 5G NR network).

Example 12:

The UE shall set the contents of the MBS interest indication as follows:
1> if UE is receiving 5G broadcast service on LTE FeMBMS cell:
2> UE considers the frequency for the 5G broadcast reception as part of the frequencies of interest.

In an embodiment, if 5GB-ServingCellMII is provided in SIB (e.g., SIB1) by the PCell and if the set of 5G broadcast frequencies for 5G broadcast reception on LTE FeMBMS cell is determined to be not empty, the UE includes bandwidth information (e.g., mbms-Bandwidth), or frequency (e.g., mbms-ROM-Freq) or subcarrier spacing (e.g., mbms-ROM-SubcarrierSpacing) in the MBS interest indication message to be reported to the 5G NR network.

In an embodiment, an example of specification (3GPP TS 38.331) is provided for setting the contents MBS interest indication message carrying the baseband resource capability reporting for 5G broadcast reception on a FeMBMS cell (i.e., LTE cell) to the serving gNB (i.e., to the 5G NR network).

Example 13:

The UE shall set the contents of the MBS interest indication as follows:
1> if 5GB-ServingCellMII is provided in SIB1 by the PCell; and
1> if the set of 5G broadcast frequencies for 5G broadcast reception on LTE FeMBMS cell, determined in accordance with (3GPP TS 36.331), is not empty:
2> include mbms-ROM-Freq, mbms-ROM-SubcarrierSpacing and mbms-Bandwidth.

In an embodiment, if reconfiguration With Sync message was included in masterCellGroup and if UE is receiving (or no longer receiving) 5G broadcast on LTE FeMBMS cell and if 5GB-ServingCellMII is provided in SIB (e.g., SIB1) by the PCell and if the UE initiated transmission of an MBS interest indication message during the last 1 second preceding reception of this RRC Reconfiguration message or if the RRC Reconfiguration message is applied due to a conditional reconfiguration execution, and the UE has initiated transmission of an MBS interest indication message after having received this RRC Reconfiguration message, the UE initiates transmission of an MBS interest indication message to the 5G NR network. A few examples are described as below:

Example 14:
1> if reconfigurationWithSync was included in spCellConfig of an MCG or SCG and when MAC of an NR cell group successfully completes a random access procedure triggered above; or,
1> if sl-PathSwitchConfig was included in reconfigurationWithSync included in spCellConfig of an MCG, and when successfully sending RRCReconfigurationComplete message (i.e., PC5 RLC acknowledgement is received from target L2 U2N Relay UE); or,
1> if rach-LessHO was included in reconfigurationWithSync included in spCellConfig of an MCG, and upon indication from lower layers that the RACH-less handover has been successfully completed; or,
1> if reconfigurationWithSync was included in spCellConfig of an MCG or SCG and the RRCReconfiguration message is applied due to an LTM cell switch execution and upon an indication from lower layer that the LTM cell switch execution has been successfully completed:
2> if reconfigurationWithSync was included in masterCellGroup and the target cell provides SIB21 or provides SIB1 including nonServingCellMII or provides SIB1 including 5GB-ServingCellMII (when UE is receiving or no longer receiving 5G broadcast on LTE FeMBMS cell):
3> if the UE initiated transmission of an MBSInterestIndication message during the last 1 second preceding reception of this RRCReconfiguration message; or
3> if the RRCReconfiguration message is applied due to a conditional reconfiguration execution, and the UE has initiated transmission of an MBSInterestIndication message after having received this RRCReconfiguration message:
4> initiate transmission of an MBSInterestIndication message in accordance with (3GPP TS 36.331).

Example 15:
1> if reconfigurationWithSync was included in spCellConfig of an MCG or SCG and when MAC of an NR cell group successfully completes a random access procedure triggered above; or,
1> if sl-PathSwitchConfig was included in reconfigurationWithSync included in spCellConfig of an MCG, and when successfully sending RRCReconfigurationComplete message (i.e., PC5 RLC acknowledgement is received from target L2 U2N Relay UE); or,
1> if rach-LessHO was included in reconfigurationWithSync included in spCellConfig of an MCG, and upon indication from lower layers that the RACH-less handover has been successfully completed; or,
1> if reconfigurationWithSync was included in spCellConfig of an MCG or SCG and the RRCReconfiguration message is applied due to an LTM cell switch execution and upon an indication from lower layer that the LTM cell switch execution has been successfully completed:
2> if reconfigurationWithSync was included in masterCellGroup and the target cell provides SIB21 or provides SIB1 including nonServingCellMII or provides SIB1 including 5GB-ServingCellMII (when UE is receiving or no longer receiving 5G broadcast on LTE FeMBMS cell):
3> if the UE initiated transmission of an MBSInterestIndication message during the last 1 second preceding reception of this RRCReconfiguration message; or
3> if the RRCReconfiguration message is applied due to a conditional reconfiguration execution, and the UE has initiated transmission of an MBSInterestIndication message after having received this RRCReconfiguration message:
4> initiate transmission of an MBSInterestIndication message in accordance with (3GPP TS 36.331).

In an embodiment, if the UE is receiving (or no longer receiving) 5G broadcast on LTE FeMBMS cell and if 5GB-ServingCellMII is provided in SIB (e.g., SIB1) by the PCell and if the UE initiated transmission of an MBSInterestIndication message during the last 1 second preceding detection of radio link failure, the UE initiates transmission of an MBS interest indication message to the 5G NR network. A few examples are described as below.

Example 16:
if UE is receiving (or no longer receiving) 5G broadcast on LTE FeMBMS cell and if 5GB-ServingCellMII is provided in SIB1 by the PCell:
2> if the UE initiated transmission of an MBSInterestIndication message during the last 1 second preceding detection of radio link failure:
3> initiate transmission of an MBSInterestIndication message in accordance with (3GPP TS 36.331).

Example 17:
if 5GB-ServingCellMII is provided in SIB1 by the PCell:
2> if the UE initiated transmission of an MBSInterestIndication message during the last 1 second preceding detection of radio link failure:
3> initiate transmission of an MBSInterestIndication message in accordance with (3GPP TS 36.331).

In an embodiment, if the UE is receiving MBMS service(s) through 5G broadcast (e.g., in receive only mode) on LTE FeMBMS and if the supportedBandCombination the UE included in UE-NR-Capability contains at least one band combination including the mbms-ROM-Freq, the UE includes mbms-ROM-Freq, mbms-ROM-SubcarrierSpacing and mbms-Bandwidth in the MBS interest indication message to be transmitted to the 5G NR network. An example is described as below.

Example 18:
1> if the UE is receiving MBMS service(s) in receive only mode on LTE FeMBMS:
2> if the supportedBandCombination the UE included in UE-NR-Capability contains at least one band combination including the mbms-ROM-Freq:
3> include mbms-ROM-Freq, mbms-ROM-SubcarrierSpacing and mbms-Bandwidth.

In an embodiment, the system (not shown) includes a memory, a processor, a communicator, and an innovative hardware such as 5G broadcast manager or controller connected to the memory and the processor.

The memory is configured to store instructions to be executed by the processor. The memory can include non-volatile storage elements. Examples of such non-volatile storage elements may include magnetic hard disks, optical discs, floppy disks, flash memories, or forms of electrically programmable memories (EPROM) or electrically erasable and programmable (EEPROM) memories. In addition, the memory may, in some examples, be considered a non-transitory storage medium. The term non-transitory may indicate that the storage medium is not embodied in a carrier wave or a propagated signal. However, the term non-transitory should not be interpreted to mean that the memory is non-movable. In some examples, the memory is configured to store larger amounts of information. In an example, a non-transitory storage medium may store data that can over time change (e.g., in random access memory (RAM) or cache).

The processor may include one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU). The processor may include multiple cores and is configured to execute the instructions stored in the memory.

The communicator includes an electronic circuit specific to a standard that enables wired or wireless communication. The communicator is configured to communicate internally between internal hardware components of the system and with external devices via one or more networks.

In an embodiment, the 5G broadcast manager or controller (or any other name is also possible) is an innovative hardware for enabling reception of 5G broadcast transmission as described above.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether or not such computer or processor is explicitly shown.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Reference is now made to FIG. 1, which illustrates a simplified block diagram of a system 100 architecture in accordance with the present disclosure. The figure illustrates three components: user equipment (UE) 102, radio access network (RAN) 104, and core network (CN) 106, each playing a critical role in the reliable reporting of baseband resource capability of the UE during multimedia broadcast multicast service (MBMS) reception.

user equipment (UE) 102 is representative of a mobile device, such as a smartphone or tablet, that serves as the user's interface for accessing mobile communication networks. This component is integral for both receiving and transmitting signals pertinent to 5G broadcast and LTE communication systems. The UE operates by sending and receiving signaling messages, including interest indication messages that articulate the baseband resource capabilities it supports—parameters critical for optimizing service configurations on the network.

Radio access network (RAN) 104 serves as the communication intermediary that connects the UE with the broader communication network infrastructure. It typically comprises of a base station or communication tower that facilitates the transmission of signals between mobile devices and the network. The RAN is responsible for managing mobile-specific signals and also interacts with the broadcast functions of the system. By coordinating the signaling exchanges between the UE and the network, the RAN ensures functional integration and resource allocation for incoming and outgoing communications.

Core network (CN) 106 encompasses the server and control components of the telecommunications network, performing essential management and processing tasks. Its functions include the reception of signals from both the UE 102 and the RAN 104, processing these signals to maintain seamless communication throughout the network infrastructure. The CN 106 ensures effective routing of data and signals, thereby supporting the dynamic configuration of the communication parameters based on the capabilities reported by the UE.

The data and control signal flow among these components is facilitated through established signaling protocols. The UE 102 initiates communication by sending MBMS interest indication messages which include parameters such as frequency, sub-carrier spacing, and bandwidth information to the RAN 104. This information is critical for the RAN 104 to appropriately configure the radio resources to optimize service delivery, particularly during scenarios such as RRC connection reconfiguration or radio link failures. The RAN processes this information and forwards it to the CN 106, which utilizes it to further optimize user connections and service parameters.

The implementation of each component follows a hybrid approach, combining both hardware and software aspects. The UE 102 can be seen as a hardware-software integrated system, where the physical device contains processing units that execute mobile communication protocols. Similarly, the radio access network includes physical base station hardware and software components that handle signal processing and communication functionalities. The CN 106 is typically implemented through server infrastructure that comprises physical servers managed by software for network control and optimization.

In some embodiments, optional components such as additional signaling nodes or alternative network topologies may be integrated within the system's architecture while still remaining aligned with the core capabilities described. For example, incorporating a dedicated multicast broadcasting component into the RAN could enhance the delivery of MBMS content, yet remains within the innovative scope of this disclosure as it relates to optimizing baseband resource reporting during various operational scenarios. As depicted in the adjacent environment of FIG. 1, these interactions exemplify the systematic coordination required for reliable data transmission and service configuration enhancements for effective 5G broadcast receipt during critical operational states.

The UE 102 may be connected to LTE or 5G NR network (NW A) 104A for availing unicast and in parallel may be availing the 5G broadcast transmission from the LTE network (NW B) 104B. Due to UE's 102 engagement on NW B 104B, some part of the UE's 102 baseband resource capability is consumed in receiving 5G broadcast transmissions (e.g., 5G broadcast transmissions may utilize lower sub-carrier spacing (SCS) like 2.5 KHz, 1.25 KHz, 0.37 KHz and correspondingly, large Fast Fourier Transforms (FFTs) are used, hybrid automatic repeat request (HARQ) support may add further processing requirements). Further, there may or may not be any coordination among NW A and NW B. also, NW A and NW B may belong to same or different network operators.

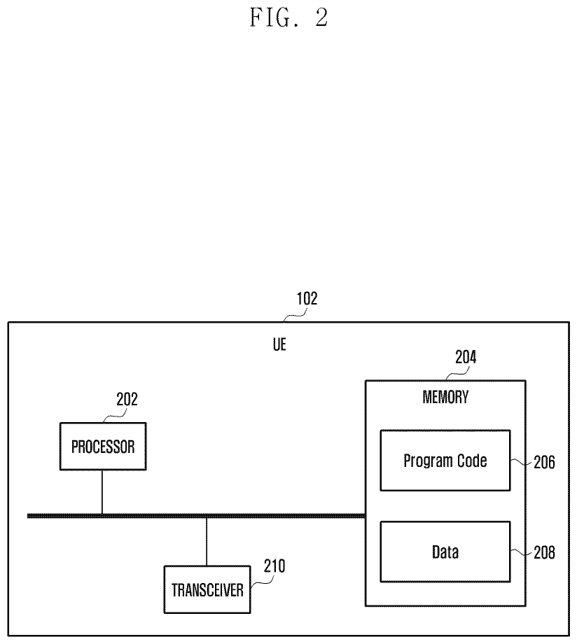

Reference is now made to FIG. 2, which illustrates an exemplary detailed block diagram of the UE 102 functionality in accordance with some embodiments of the present disclosure. This diagram delineates the interaction between the various components enabling the reliable reporting of baseband resource capability during multimedia broadcast multicast service (MBMS) reception.

The primary component illustrated in FIG. 2 is the processor 202, which acts as the central processing unit of the UE 102. The processor 202 is responsible for executing program code stored in memory 204 and dynamically processing data necessary for the operation of the UE 102. It coordinates the interaction between other components, such as the memory 204, transceiver 210, and the external network, to ensure efficient handling of communication and processing tasks. The processor 202 interprets input signals and executes programmed instructions, making it essential in achieving the objectives of reliable resource capability reporting. Although one processor 202 is illustrated, there could be one or more processors to perform the functions of the processor 202.

In an embodiment, the processor 202 is configured to receive from a serving cell 104A, a signaling message indicating an allowed transmission of a multimedia broadcast multicast service (MBMS) interest indication message. Further, the processor 202 is configured to transmit the MBMS interest indication message to the serving cell 104A in response to receiving the signalling message and at least one trigger condition comprising: (i) reception of a radio resource control (RRC) reconfiguration including mobility information for handover, or (ii) execution of a conditional reconfiguration, or (iii) detection of radio link failure followed by RRC connection reestablishment. The MBMS interest indication message comprises baseband resource capability reporting parameters for receiving broadcast transmission on a cell 104B. In an embodiment, the serving cell is a 5G NR cell and the broadcast transmission cell is an LTE FeMBMS cell.

In an embodiment, the processor 202 is configured to transmit the baseband resource capability reporting parameters including at least one of frequency information, sub-carrier spacing information, or bandwidth information related to the baseband resource capability.

In an embodiment, the processor 202 is configured to receive the signaling message as at least one of a SystemInformationBlockType2 or an mbms-ROM-ServiceIndication received in SystemInformationBlockType2 that is indicative of the baseband resource capability reporting parameters necessary for the transmission of the MBMS interest indication message.

In an embodiment, the processor 202 is configured to for transmitting the MBMS interest indication message based on detecting the radio link failure the processor 202 is further configured to determine a radio link status of the UE with the serving cell with the transmission.

In an embodiment, the processor 202 is further configured to transmit the MBMS interest indication message when the UE 102 has initiated or transmitted the interest and/or assistance signaling message within a predetermined time window preceding the corresponding trigger condition.

In an embodiment, the processor 202 is further configured to transmit the MBMS interest indication message in the predetermined time window of one second preceding the respective one of: the reception of the RRC reconfiguration including mobility information; execution of the conditional reconfiguration; or detection of radio link failure. Prior to transmitting the MBMS interest indication message, the processor 202 is further configured to verify a valid version of a broadcast/multicast system information block (e.g., SIB15), if present; and determine a set of broadcast/multicast frequencies of interest and a set of broadcast/multicast services of interest.

In an embodiment, the processor 202 is further configured to transmit the MBMS interest indication message to a target cell indicated in the mobility information, where the baseband resource capability report is used by a network associated with the target cell to optimize UE configuration for unicast during or after handover.

Linked to the processor 202 is memory 204, which serves a dual purpose. The memory 204 stores the program code 206 that comprises the instructions necessary for the processor's operations, ensuring that the UE 102 can perform various functions associated with both MBMS and overall communication tasks. The memory 204 also houses data 208, which encompasses any necessary information required during task execution. The data 208 facilitates effective processing and supports the seamless operation of the UE, primarily during scenarios such as RRC connection reconfiguration or radio link failure.

The transceiver 210, may be responsible for managing bidirectional communication between the UE 102 and the network 104, 106. The transceiver 210 may be responsible for sending and receiving communication signals, thus facilitating the UE's 102 ability to interact within the cellular network environment. The transceiver 210 receives input from the processor 202 in the form of control commands and subsequently transmits MBMS interest indication messages. It also receives acknowledgment from the network 104, 106, which informs the processor 202 of the successful reception of the transmitted messages, ensuring the efficient utilization of resources.

The data 208 may include parameters such as frequency, sub-carrier spacing, and bandwidth information relevant for MBMS reception. This data 208 is not only used for processing but also forwarded to the transceiver 210 as part of the MBMS interest indication message when the UE transmits its resource capability report.

The flow of data, signals, or control commands between these components occurs in a synchronized fashion guided by the program code 206 executed by the processor 202. For instance, upon the processor determining the need for a resource capability report—triggered by reception of a signaling message from the network—the corresponding data is retrieved from memory 204 and forwarded to the transceiver 210 for transmission. This interaction between the processor, memory, and transceiver forms a cohesive system that allows the UE to effectively manage its communication efforts within the context of both normal operations and on the occurrence of exceptional scenarios like handover, conditional reconfiguration, or radio link failures.

In summary, as illustrated in FIG. 2, the interaction among processor 202, memory 204, program code 206, the data 208, and transceiver 210 integrates to facilitate the core functions of the UE 102 necessary to implement the aspects of the present disclosure. However, in some implementations, a person skilled will appreciate that fewer or more elements as disclosed in the present disclosure may be involved in implementing the present disclosure.

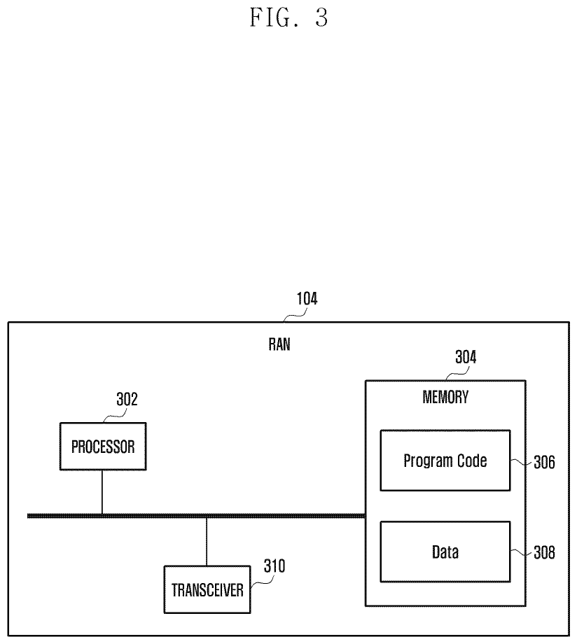

Reference is now made to FIG. 3, which illustrates a detailed block diagram of the RAN 104 depicting the architecture for reliable reporting of the baseband resource capability in a UE 102 within a wireless communication network 100. The figure illustrates five primary components: processor 302, memory 304, program code 306, the data 308, and transceiver 310.

Starting with processor 302, this component serves as the central processing unit of the RAN 104. It is responsible for executing the program code to manage the overall operations of the device. The processor 302 also handles the functionalities necessary for processing data concerning the wireless communication, including the generation and transmission of MBMS interest indication messages that report the UE's 102 baseband resource capabilities. This capability is crucial to ensuring that configurations provided by the network are tailored to the UE's actual operating conditions, thus optimizing performance.

Connected to processor 302 is memory 304, which fulfils dual roles for the system. Primarily, it serves to store program code 306, which comprises of the instructions the processor executes to operate effectively within the network. This code governs how the processor interacts with other components and how it addresses network signaling conditions. Additionally, memory 304 stores the data 308, which encompasses the necessary operational parameters and information required during task execution. This data 308 may include, for example, the frequency, sub-carrier spacing, and bandwidth specifications relevant to the 5G broadcast transmission.

The program code 306 includes routines that manage the reception of signaling messages from the network and the subsequent preparation of the MBMS interest indication message. The execution of this code ensures that the UE 102 can dynamically respond to network conditions, whether through handover, conditional reconfiguration, or during instances of radio link failure, as signified in claims regarding the timing of message transmission.

The data 308 holds specific information necessary for generating the MBMS interest indication message, which comprises parameters such as frequency information, sub-carrier spacing, and bandwidth, essential for the efficient processing and delivery of broadcast services. The processor 302 retrieves this data from memory when establishing communication with the network, ensuring that the messages reflect the current operational state of the UE 102.

The transceiver 310 is the communication interface of the UE 102, responsible for bidirectional signal management. It transmits the generated MBMS interest indication messages to the network based on direction and control commands provided by the processor. The transceiver 310 also receives acknowledgment signals from the network, which are utilized to confirm the successful transmission of messages. The interaction between the transceiver 310 and processor 302 is vital for maintaining communication integrity, especially when undergoing transmission during dynamic conditions such as handover.

Overall, the integration of processor 302, memory 304, program code 306, the data 308, and transceiver 310 within the UE 102 represents a cohesive architecture designed to manage and optimize resource capability reporting during multimedia broadcast multicast service scenarios. This architecture supports robust communication protocols necessary to enhance the user experience in terms of reliability and performance during 5G broadcast transmissions.

The processor 302 is configured to broadcast system information indicating availability of receive-only broadcast/multicast service. In response to receiving, from the UE 1-2, an MBMS interest indication message including a baseband resource capability report, the processor 303 configures the UE 102 with parameters optimized for unicast in response to broadcast reception based at least on a receive-only frequency identifier, subcarrier spacing information, and bandwidth information reported by the UE 102. In an embodiment, the processor 302 applies the configuration during handover executed via mobility information or following RRC connection reestablishment after radio link failure.

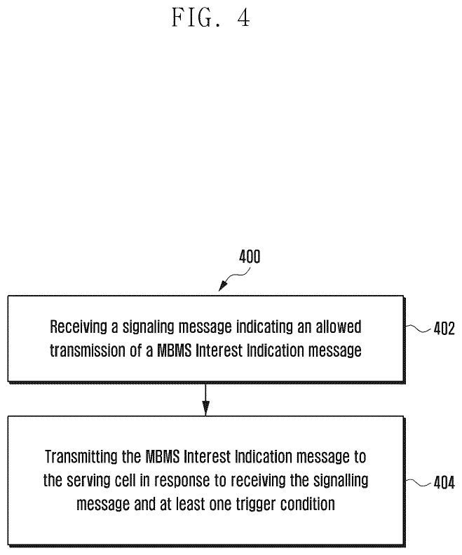

Reference is now made to FIG. 4, which illustrates a flowchart depicting the transmission process of a multimedia broadcast multicast service (MBMS) interest indication message in accordance with some embodiments of the present disclosure. The flowchart comprises of two main steps, where each step is sequentially linked for the seamless execution of the process.

The process begins at Step 402, which involves receiving a signaling message indicating an allowed transmission of an MBMS interest indication message. This signaling message acts as a notification from the serving cell to the user equipment (UE) that facilitates further actions. For example, upon receiving this message, the UE validates its status and prepares to engage in signaling regarding its resource capabilities. This step functions as a primary trigger for the subsequent actions in the process. The receipt of this signaling message can arise during specific operational scenarios, notably during radio resource control (RRC) reconfiguration setups or conditional changes in network configuration.

Following the completion of Step 402, the method comprises to Step 404, where the UE 102 transmits the MBMS interest indication message to the serving cell. This transmission occurs specifically in response to the signaling message from Step 402 and contingent upon the fulfilment of at least one trigger condition. For instance, the UE may initiate this message transmission if it has previously signalled its interest in MBMS services while meeting the timeline constraints—specifically, the UE must have indicated interest within a predefined timeframe preceding the relevant trigger, such as during a radio link failure or connectivity re-establishment event. The MBMS interest indication message contains critical data, including the baseband resource capability reporting parameters essential for optimizing the reception of broadcast transmissions under conditions defined within the communication environment.

In a typical scenario where a UE 102 operates within an evolving network, such as when it faces a handover to a new cell or experiences radio link failures, the entire process enables the UE 102 to efficiently report its capabilities. For example, upon receiving a signaling message from a serving cell while in a handover phase, the UE 102 evaluates its current resource capabilities and prepares to communicate this information back to the serving cell. Consequently, the UE 102 proceeds to transmit the MBMS interest indication, highlighting its ability to successfully receive broadcasts, including specific parameters such as frequency and bandwidth allocations necessary for optimal service.

The described sequence ensures an efficient reporting mechanism whereby the serving cell can update its resource allocation strategies based on current conditions. This functionality enhances the overall service integrity within 5G networks, particularly during transitions or failure scenarios, thereby providing operators with necessary insights for dynamic resource allocation.

The UE 102 reports the MBMS interest indication indicating the baseband resource capability including reporting parameters comprising at least one of frequency information, sub-carrier spacing information, or bandwidth information related to the baseband resource capability.

In an embodiment, the signaling message comprises at least one of a SystemInformationBlockType15 or an mbms-ROM-ServiceIndication received in SystemInformationBlockType2 that is indicative of the baseband resource capability reporting parameters necessary for the transmission of the MBMS interest indication message.

In an embodiment, transmitting the MBMS interest indication message based on detecting the radio link failure comprises determining a radio link status of the UE with the serving cell providing the broadcast transmission.

In an embodiment, transmitting of the MBMS interest indication message occurs when the UE has initiated or transmitted the interest and/or assistance signaling message within a predetermined time window preceding the corresponding trigger condition. The predetermined time window is one second preceding the respective one of: the reception of the RRC reconfiguration including mobility information; execution of the conditional reconfiguration; or detection of radio link failure.

In an embodiment, prior to transmitting the MBMS interest indication message, the method comprises verifying a valid version of a broadcast/multicast system information block (e.g., SIB15), if present and determining a set of broadcast/multicast frequencies of interest and a set of broadcast/multicast services of interest.

In an embodiment, the method comprises transmitting the MBMS interest indication message to a target cell indicated in the mobility information, wherein the baseband resource capability report is used by a network associated with the target cell to optimize UE configuration for unicast reception during or after handover.

In an embodiment, an example of proposed specification (3GPP TS 36.331) is provided for transmitting by the UE 102, in the RRCConnectionReconfiguration with mobilityControlInfo scenario or conditional reconfiguration scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

In an embodiment, an example of proposed specification (3GPP TS 36.331) is provided for transmitting by the UE in the RRC connection reconfiguration with mobility control information (mobilityControlInfo) scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

In an embodiment, an example of proposed specification (3GPP TS 36.331) is provided for transmitting by the UE in the radio link failure scenario, the MBMS interest indication message carrying the baseband resource capability reporting for 5G broadcast reception on a LTE FeMBMS cell, to a target LTE cell, in case of receiving mbms-ROM-ServiceIndication in SystemInformationBlockType2 from PCell (i.e., target cell).

The technical advantages include a systematic approach to reporting baseband resource capabilities, allowing for more responsive and adaptive network configurations. This leads to improved efficiency in resource utilization, mitigates potential decoding failures, and optimizes throughput during service interruptions or transitional states. Furthermore, the ability of the UE to communicate its readiness in real-time to the network distinguishes this process as particularly scalable, accommodating various operational scenarios without incurring additional overhead associated with legacy communication techniques.

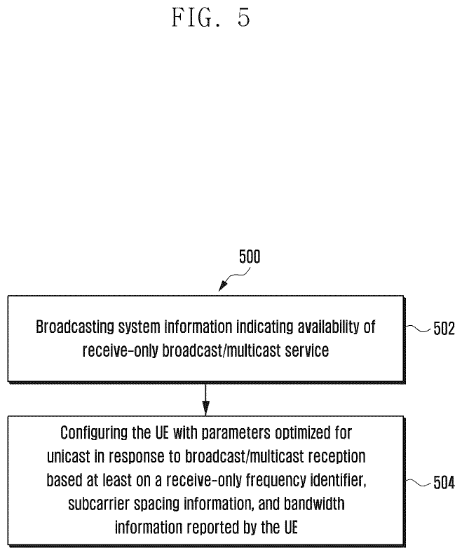

Reference is now made to FIG. 5, which illustrates a flowchart for configuring user equipment (UE) based on broadcast system information to optimize unicast parameters in accordance with some embodiments of the present disclosure.

The method begins at Step 502, where the process initiates with broadcasting system information that indicates the availability of a receive-only broadcast/multicast service. This broadcast is essential as it informs the UE 102 about the relevant service it may access, leading to efficient utilization of its resources. For example, if a mobile device receives this broadcast message, it recognizes that it can avail itself of certain multimedia content transmitted via the network specifically designed for receive-only scenarios. This step represents the starting point of the process leading into more dynamic configurations.

After successfully processing the information broadcast at Step 502, the method then transitions to Step 504. This step involves configuring the UE 102 with parameters optimized for unicast in response to the previously received broadcast/multicast information. The optimization of unicast parameters is based on several key criteria, including a receive-only frequency identifier, subcarrier spacing information, and bandwidth information reported by the UE.

For instance, consider a scenario where a smartphone is receiving a broadcast about a live sports event. After receiving the broadcast system information in Step 502, the RAN 104, upon evaluating the parameters such as frequency and available bandwidth, configures the UE 102 in Step 504 to allocate its communication resources efficiently for unicast services, like accessing additional live updates or replays of the event in a more stable and faster manner. The parameters utilized help ensure that the user experiences minimal buffering while viewing the additional content.

Thus, this method significantly enhances the efficiency and reliability of data transmission within the system. The described process allows the UE 102 to continually adapt to the dynamic requirements of the broadcast service, making the overall communication process more robust when compared to previous techniques.

In some embodiments, this method contributes to reducing decoding failures and optimizing throughput by allowing the UE 102 to assess and report its capabilities accurately and quickly, especially during high-demand scenarios like sports broadcasting or during major media events. These capabilities can prominently improve service quality and user experience across a variety of contexts within wireless communications, underpinning its advantageous position over prior art techniques that do not effectively allow for such dynamic resource management during unicast configuration transitions.

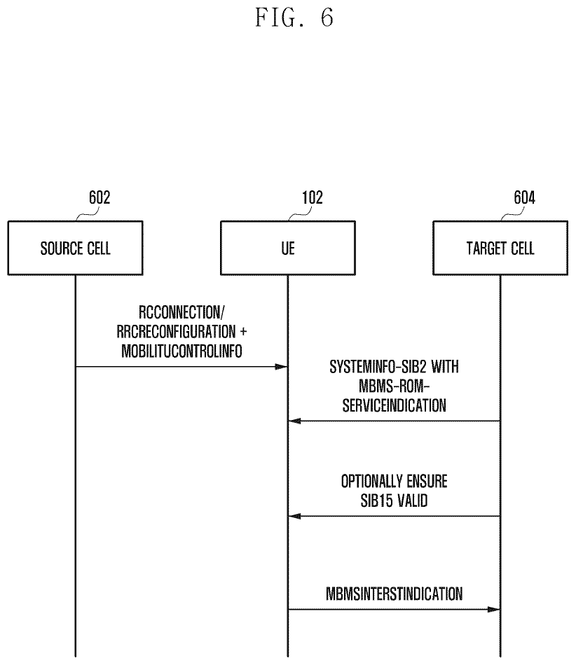

Reference is now made to FIG. 6, which illustrates a sequence diagram for the transmission of an MBMS interest indication message during RRC connection reconfiguration in accordance with some embodiments of the present disclosure. The diagram represents a comprehensive interaction between key components in a wireless communication environment, specifically focusing on the transmission of system information and subsequent reporting procedures within a 5G broadcast context.

The figure highlights three primary elements: the source cell 602, the user equipment (UE) 102, and the target cell 604. source cell 602, signifying the primary communication cell, before the mobility i.e., before the reconfiguration process. The UE 102, actively receiving and processing signals pertinent to both RRC connection reconfiguration and MBMS capabilities. The target cell 604 signifies the cell to which the UE connects following the reconfiguration process, and transmits MBMS interest indication message ensuring it appropriately configures its resources for optimal broadcast and multicast reception.

In this setup, UE 102 receiving the system information block type 2 (SIB2) from target cell (PCell) 604, which comprises an MBMS-ROM-ServiceIndication, while the UE 102 engages in processing RRC connection reconfiguration along with mobilityControlInfo. This process includes generating an MBMS interest indication, enabling the UE to report its resource capabilities, which are essential for configuring appropriate communication parameters for service reception. It is imperative that the system checks for the validity of SIB15, if present, ensuring it contains essential information conducive to MBMS reception.

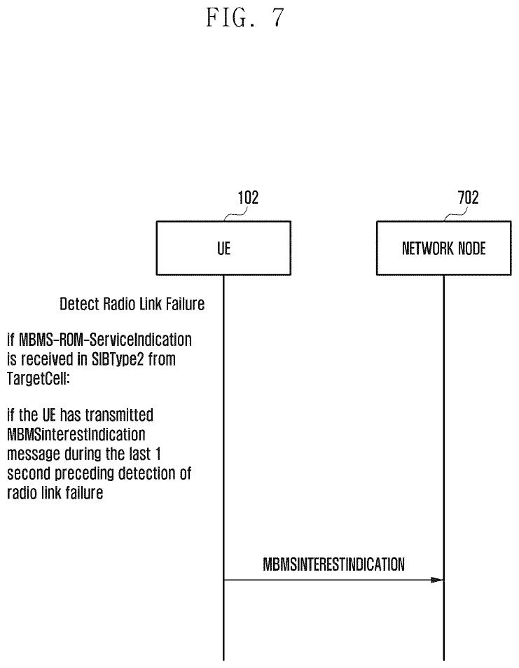

Reference is now made to FIG. 7, which illustrates an exemplary sequence diagram for transmitting multimedia broadcast multicast service (MBMS) interest indication messages during radio link failure scenarios in accordance with some embodiments of the present disclosure. The diagram highlights two primary components: UE 102 and Network Node 702. These components interact to ensure timely communication during instances when the UE detects a radio link failure and initiates necessary connection reestablishment protocols.

The process is initiated when the UE 102 identifies a failure in its radio link with the network node 702 (i.e., source cell), triggering it to swiftly initiate connection reestablishment. This action is imperative for restoring service continuity, particularly in critical broadcasting contexts where uninterrupted media reception is essential. The function of network node 702 is critical, as it serves as the operator's communication interface with the UE 102. Upon receiving indications of a radio link failure from the UE 102, the network node facilitates the reestablishment of the connection by coordinating resource configurations and ensuring the network can adequately support the UE's requirements. If mbms-ROM-ServiceIndication is received in SystemInformationBlockType2 from network node (i.e., target cell (PCell)) and if the UE has transmitted an MBMSInterestIndication message during the last 1 second preceding detection of radio link failure, the UE initiates transmission of the MBMSInterestIndication message to report its capabilities. The dynamic nature of the communication allows the network node to adaptively configure settings based on the UE's reported capabilities, optimizing the resource allocation essential for MBMS service delivery. It can be noted that source cell and target cell may belong to same network node or different network nodes, without the loss of generality.

In some embodiments, the seamless execution of the described processes exemplified in the diagram indicates a robust framework for responding to network challenges effectively. By combining timely detection, prompt reporting, and adaptive resource management, the inventive mechanism aims to significantly diminish the issues associated with radio link failures, marking a clear progression toward enhanced user experiences in 5G environments where broadcast continuity is paramount.

FIG. 8 illustrates a sequence diagram that illustrates the signaling approach to inform UEs whether they are allowed or not allowed to send the MBS interest indication message carrying the baseband resource capability report based on reception of 5G broadcast transmission from LTE FeMBMS cell, to the 5G NR network, according to embodiments as disclosed herein.

The UE 102 may be connected to 5G NR network (NW A) 104A for availing unicast and in parallel may be availing the 5G broadcast transmission from the LTE network (NW B) 104B. Due to UE's 102 engagement on NW B 104B, some part of the UE's 102 baseband resource capability is consumed in receiving 5G broadcast transmissions (e.g., 5G broadcast transmissions may utilize lower sub-carrier spacing (SCS) like 2.5 KHz, 1.25 KHz, 0.37 KHz and correspondingly, large Fast Fourier Transforms (FFTs) are used, Hybrid automatic Repeat Request (HARQ) support may add further processing requirements). Consequently, the UE 102 may not be able to offer the full baseband resource capability towards the 5G NR unicast operations (NW A) 104A. In an embodiment, the SIB carries at least one parameter that conveys to the UEs 102 in the 5G NR cell 104A, whether the MBS interest indication message carrying the baseband resource capability reporting for 5G broadcast reception on a FeMBMS cell (i.e., LTE cell) is allowed to be transmitted to the serving gNB (i.e., to the 5G NR network) 104A. The at least one parameter indicating whether the MBS interest indication message carrying the baseband resource capability reporting for 5G broadcast reception on a FeMBMS cell (i.e., LTE cell) is allowed to be transmitted to the serving gNB may be termed as 5GB-ServingCellMII (or mbms-ROM-ServiceIndication or 5GB-ServiceIndication or 5GB-nonServing CellMII). The 5GB-ServingCellMII or mbms-ROM-ServiceIndication or 5GB-ServiceIndication or 5GB-nonServingCellMII may be used interchangeably. The parameter may be configured and/or set to be TRUE to indicate allowing of sending MBS interest indication message carrying the baseband resource capability reporting for 5G broadcast reception. The parameter may not be configured (i.e., absent) or be configured and set as FALSE to indicate not allowing of sending MBS interest indication message carrying the baseband resource capability reporting for 5G broadcast reception. In an embodiment, the existing parameter nonServingCellMII is reused to also indicate whether the MBS interest indication message carrying the baseband resource capability reporting for 5G broadcast reception on a FeMBMS cell (i.e., LTE cell) is allowed to be transmitted to the serving gNB (i.e., to the 5G NR network). Further, the non-serving cell may also include LTE FeMBMS cell from where UE 102 is receiving 5G broadcast transmission. As shown in the FIG. 8, the UE 102 determines a change in the baseband resource capability due to reception of 5G broadcast transmissions and triggers MII.

An MBS capable or 5G broadcast capable UE in RRC_CONNECTED may initiate the procedure in several cases including upon successful connection establishment/resume, upon entering or leaving the broadcast service area, upon MBS broadcast session start or stop, upon change of interest, upon change of priority between MBS broadcast reception and unicast/multicast reception, upon change to a PCell providing SIB21 (i.e., where the SIB1 scheduling information contains SIB21), upon receiving SIB20 of an SCell via dedicated signalling, upon handover, and upon RRC connection re-establishment, upon change to a PCell providing nonServingCellMII in SIB1, upon starting or stopping reception of MBS broadcast service on a non-serving cell, upon change of CFR information or subcarrier spacing for MBS broadcast reception on a non-serving cell, upon change to a PCell providing 5GB-ServingCellMII in SIB1, upon starting or stopping reception of 5G broadcast service on a LTE FeMBMS cell, upon change of bandwidth information or frequency or subcarrier spacing for 5G broadcast reception on a LTE FeMBMS cell. If the UE does not have the CFR information and subcarrier spacing for MBS broadcast reception on a non-serving cell at the time it sends the MBS interest indication, the UE sends another MBS interest indication after it has acquired this information from the non-serving cell. If the UE does not have the Bandwidth information and subcarrier spacing for 5G broadcast reception on a LTE FeMBMS cell at the time it sends the MBS interest indication, the UE sends another MBS interest indication after it has acquired this information from the LTE FeMBMS cell.

After receiving the baseband resource capability from the UE 102, the 5G NR Cell 104A updates the unicast configuration for the UE 102. The 5G NR Cell 104A transmits the updated unicast configuration to the UE 102 in the RRCReconfiguraiton message to provide unicast service as per the updated configuration.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items or items. It must also be noted that as used herein, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. Accordingly, the embodiments of the disclosure are intended to be illustrative, but not limiting, of the scope of the disclosure.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, information indicating that the UE is allowed to send a multimedia broadcast multicast service (MBMS) interest indication message; and
in case that at least one of (i) the UE having initiated a transmission of the MBMS interest indication message during a last 1 second preceding reception of a radio resource control (RRC) connection reconfiguration message including mobility control information, (ii) the RRC connection reconfiguration message being applied due to a conditional reconfiguration execution, or (iii) the UE having transmitted the MBMS interest indication message during a last 1 second preceding detection of radio link failure, transmitting, to the base station, the MBMS interest indication message,
wherein the MBMS interest indication message comprises resource information for receiving MBMS.

2. The method of claim 1, wherein the resource information includes at least one of frequency information, sub-carrier spacing information, or bandwidth information.

3. The method of claim 1, wherein the information indicating that the UE is allowed to send the MBMS interest indication message is received in a system information block 2 (SystemInformationBlockType2).

4. The method of claim 1, further comprising:
in case that a system information block 15 (SystemInformationBlockType15 ) associated with MBMS services is received, and in case that the at least one of (i) the UE having initiated the transmission of the MBMS interest indication message during the last 1 second preceding reception of the RRC connection reconfiguration message including the mobility control information, (ii) the RRC connection reconfiguration message being applied due to the conditional reconfiguration execution, or (iii) the UE having transmitted the MBMS interest indication message during the last 1 second preceding detection of the radio link failure, transmitting, to the base station, the MBMS interest indication message.

5. The method of claim 1, further comprising:
ensuring having a valid version of a system information block 15 (SystemInformationBlockType15), if present; and
determining at least one of a set of MBMS frequencies of interest or a set of MBMS services of interest.

6. A user equipment (UE) in a wireless communication system, the UE comprising:
a memory; and
at least one processor configured to:
receive from a base station, information indicating that the UE is allowed to send of a multimedia broadcast multicast service (MBMS) interest indication message, and
in case that at least one of (i) the UE having initiated a transmission of the MBMS interest indication message during a last 1 second preceding reception of a radio resource control (RRC) connection reconfiguration message including mobility control information, (ii) the RRC connection reconfiguration message being applied due to a conditional reconfiguration execution, or (iii) the UE having transmitted the MBMS interest indication message during a last 1 second preceding detection of radio link failure, transmit, to the base station, the MBMS interest indication message,
wherein the MBMS interest indication message comprises resource information for receiving MBMS.

7. The UE of claim 6, wherein the resource information includes at least one of frequency information, sub-carrier spacing information, or bandwidth information.

8. The UE of claim 6, wherein the information indicating that the UE is allowed to send the MBMS interest indication message is received in a system information block 2 (SystemInformationBlockType2).

9. The UE of claim 6, wherein the at least one processor is further configured to:
in case that a system information block 15 (SystemInformationBlockType15) associated with MBMS services is received, and in case that the at least one of (i) the UE having initiated the transmission of the MBMS interest indication message during the last 1 second preceding reception of the RRC connection reconfiguration message including the mobility control information, (ii) the RRC connection reconfiguration message being applied due to the conditional reconfiguration execution, or (iii) the UE having transmitted the MBMS interest indication message during the last 1 second preceding detection of the radio link failure, transmit, to the base station, the MBMS interest indication message.

10. The UE of claim 6, wherein the at least one processor is further configured to:
ensure having a valid version of system information block 15 (SystemInformationBlockType15), if present, and
determine at least one of a set of MBMS frequencies of interest or a set of MBMS services of interest.

11. A method performed by a base station in a wireless communication system, the method comprising:
transmitting, to a user equipment (UE), information indicating that the UE is allowed to send a multimedia broadcast multicast service (MBMS) interest indication message; and
in case that at least one of (i) the UE having initiated a transmission of the MBMS interest indication message during a last 1 second preceding reception of a radio resource control (RRC) connection reconfiguration message including mobility control information, (ii) the RRC connection reconfiguration message being applied due to a conditional reconfiguration execution, or (iii) the UE having transmitted the MBMS interest indication message during a last 1 second preceding detection of radio link failure, receiving, from the UE, the MBMS interest indication message,
wherein the MBMS interest indication message comprises resource information for receiving MBMS.

12. The method of claim 11, wherein the resource information includes at least one of frequency information, sub-carrier spacing information, or bandwidth information.

13. The method of claim 11, wherein the information indicating that the UE is allowed to send the MBMS interest indication message is received in a system information block 2 (SystemInformationBlockType2).

14. The method of claim 11, further comprising:
in case that a system information block 15 (SystemInformationBlockType15) associated with MBMS services is received, and in case that the at least one of (i) the UE having initiated the transmission of the MBMS interest indication message during the last 1 second preceding reception of the RRC connection reconfiguration message including the mobility control information, (ii) the RRC connection reconfiguration message being applied due to the conditional reconfiguration execution, or (iii) the UE having transmitted the MBMS interest indication message during the last 1 second preceding detection of the radio link failure, receiving, from the UE, the MBMS interest indication message.

15. The method of claim 11, wherein a valid version of a system information block 15 (SystemInformationBlockType15) is ensured, if present, and
wherein at least one of a set of MBMS frequencies of interest or a set of MBMS services of interest is included in the MBMS interest indication message.

16. A base station in a wireless communication system, the base station comprising:
a memory; and
at least one processor configured to:
transmit, to a user equipment (UE), information indicating that the UE is allowed to send a multimedia broadcast multicast service (MBMS) interest indication message; and
in case that at least one of (i) the UE having initiated a transmission of the MBMS interest indication message during a last 1 second preceding reception of a radio resource control (RRC) connection reconfiguration message including mobility control information, (ii) the RRC connection reconfiguration message being applied due to a conditional reconfiguration execution, or (iii) the UE having transmitted the MBMS interest indication message during a last 1 second preceding detection of radio link failure, receive, from the UE, the MBMS interest indication message,
wherein the MBMS interest indication message comprises resource information for receiving MBMS.

17. The base station of claim 16, wherein the resource information includes at least one of frequency information, sub-carrier spacing information, or bandwidth information.

18. The base station of claim 16, wherein the information indicating that the UE is allowed to send the MBMS interest indication message is received in a system information block 2 (SystemInformationBlockType2).

19. The base station of claim 16, wherein the at least one processor is further configured to:
in case that a system information block 15 (SystemInformationBlockType15) associated with MBMS services is received, and in case that the at least one of (i) the UE having initiated the transmission of the MBMS interest indication message during the last 1 second preceding reception of the RRC connection reconfiguration message including the mobility control information, (ii) the RRC connection reconfiguration message being applied due to the conditional reconfiguration execution, or (iii) the UE having transmitted the MBMS interest indication message during the last 1 second preceding detection of the radio link failure, receive, from the UE, the MBMS interest indication message.

20. The base station of claim 16, wherein a valid version of a system information block 15 (SystemInformationBlockType15) is ensured, if present, and
wherein at least one of a set of MBMS frequencies of interest and a set of MBMS services of interest is included in the MBMS interest indication message.
